(19) United States
(12) Patent Application Publication
(10) Pub. No.: US 2025/0252962 A1
(43) Pub. Date: Aug. 7, 2025

(54) System and Methods for Upsampling of Decompressed Audio Data Using a Neural Network

(71) Applicant: AtomBeam Technologies Inc., Moraga, CA (US)

(72) Inventors: Zhu Li, Overland Park, KS (US); Brian Galvin, Silverdale, WA (US); Paras Maharjan, Kansas City, MO (US)

(21) Appl. No.: 19/186,594

(22) Filed: Apr. 22, 2025

Related U.S. Application Data
(63) Continuation-in-part of application No. 18/410,942, filed on Jan. 11, 2024.
Application No. 18/410,942 is a continuation-in-part of application No. 18/537,728, filed on Dec. 12, 2023, now Pat. No. 12,058,333.

(51) Int. Cl. G10L 19/008; G10L 25/30; G10L 25/60

(52) U.S. Cl. CPC G10L 19/008; G10L 25/30; G10L 25/60

(57) ABSTRACT

A computer system for upsampling decompressed audio data after lossy compression using specialized neural network techniques. The system processes compressed audio channels through an audio pre-processor that extracts spectral information, detects speech activity, segments audio, and normalizes input levels. A trained deep learning algorithm with multi-channel transformers using channel-wise and self-attention mechanisms recovers information lost during compression. The system further enhances audio quality through a time-frequency domain transformer applying Fourier transforms and Mel-scale frequency processing, while a perceptual quality assessor employing psychoacoustic models evaluates the output. This specialized audio processing approach significantly improves reconstructed audio quality by leveraging correlations between audio channels, addressing both spectral and temporal features, and optimizing for human perception characteristics, resulting in higher fidelity audio reproduction from compressed formats.

### CROSS-REFERENCE TO RELATED APPLICATIONS

Priority is claimed in the application data sheet to the following patents or patent applications, each of which is expressly incorporated herein by reference in its entirety:
Ser. No. 18/410,942
Ser. No. 18/537,728

### BACKGROUND OF THE INVENTION

### Field of the Art

The present invention is in the field of data compression, and more particularly is directed to the problem of recovering audio data lost from lossy compression and decompression.

### Discussion of the State of the Art

For many applications, such as streaming audio and video, lossy compression techniques such as MP3, AAC, and HEVC (high-efficiency video coding) are widely used to optimize bandwidth and storage efficiency. By definition, lossy compression reduces the amount of data required to represent a signal by discarding certain details deemed less perceptually important. However, this process inevitably results in a loss of fidelity, with audio compression causing degradation in speech clarity, loss of high-frequency components, and the introduction of compression artifacts such as pre-echo and quantization noise. In the case of video compression, this manifests as blurring and pixelation, particularly in low-bandwidth environments.

In the context of audio data, compression artifacts become particularly problematic in applications requiring high intelligibility and fidelity, such as telecommunications, voice assistants, and streaming music services. Standard codecs such as MP3, AAC, and Opus employ psychoacoustic models to determine which information to discard based on human hearing sensitivity. While effective for reducing bit rates, these codecs still struggle with maintaining the full richness of speech and music, particularly at lower bit rates. Speech compression techniques, such as those used in telephony (e.g., AMR, EVS), often result in muffled or robotic-sounding speech, affecting user experience in real-time communications.

Deep learning-based approaches have recently emerged as a promising solution for mitigating compression-related losses. Neural networks have been successfully employed for super-resolution in images and videos, and more recently, researchers have explored their potential for audio enhancement and upsampling. These models aim to reconstruct missing details from compressed signals by learning from high-quality reference datasets. However, existing deep learning-based methods are often computationally expensive and not optimized for real-time applications such as live speech enhancement and streaming audio.

While these advancements offer potential improvements, existing methods remain limited in their ability to fully reconstruct lost audio information, particularly in multi-channel environments where spatial consistency must be preserved. Additionally, current neural upsampling techniques often fail to account for perceptual audio quality metrics, leading to reconstructions that may be mathematically accurate but not perceptually pleasing.

What is needed is a system and method for upsampling decompressed audio data after lossy compression using a neural network, incorporating specialized deep learning techniques to restore missing spectral information, reconstruct phase relationships, and enhance perceptual audio quality while maintaining computational efficiency for real-time applications

### SUMMARY OF THE INVENTION

The inventor has conceived and reduced to practice a system and methods for upsampling of decompressed audio data after lossy compression using a neural network that integrates AI-based techniques to restore lost information and enhance perceptual audio quality. The system incorporates a novel audio-specific neural upsampler that applies deep learning methods, including convolutional layers for temporal pattern extraction, recurrent layers for sequence modeling, and a multi-channel transformer utilizing attention mechanisms optimized for phonetic structures. Additionally, the system introduces a time-frequency domain transformer to refine spectral and phase information, leveraging short-time Fourier transforms and Mel-scale frequency processing. The system further includes a perceptual quality assessor that evaluates and refines audio reconstructions using psychoacoustic models. This hybrid approach addresses both local and global dependencies within audio data, mitigating compression artifacts and improving fidelity in reconstructed audio. The system's outputs enable effective recovery of lost details while preserving the integrity of speech and multi-channel audio streams.

In a preferred embodiment, a system for upsampling decompressed audio data after lossy compression using a neural network is disclosed. The system comprises a computing device with at least a memory and a processor, a trained deep learning algorithm configured to restore lost information from a compressed bitstream, and a decoder that decompresses and processes the bitstream before passing it to the deep learning algorithm. The system further includes an audio pre-processor that extracts spectral information, detects speech activity, segments the audio, and normalizes input levels, ensuring high-quality reconstruction. The trained deep learning algorithm utilizes a multi-channel transformer to recover missing information, followed by a time-frequency domain transformer that enhances the reconstructed audio by refining spectral resolution and phase consistency. Finally, a perceptual quality assessor evaluates the reconstructed signal, ensuring that it aligns with human auditory perception.

In an embodiment, a method for upsampling decompressed audio data after lossy compression using a neural network is disclosed. The method comprises receiving a compressed bitstream containing two or more substantially correlated audio channels, decompressing the bitstream, and processing the decompressed data through an audio pre-processor to extract relevant features. The processed signal is then input into a trained deep learning algorithm that reconstructs missing information by leveraging learned correlations between audio channels. The reconstructed signal is further enhanced using a time-frequency domain transformer, which refines spectral characteristics and phase relationships, before being evaluated by a perceptual quality assessor that ensures perceptually accurate audio restoration.

In an aspect of an embodiment, the trained deep learning algorithm is a neural network designed to recover signals from a compressed bitstream.

In an aspect of an embodiment, the trained deep learning algorithm includes a multi-channel transformer with attention mechanisms to capture inter-channel dependencies and enhance reconstruction accuracy.

In an aspect of an embodiment, the audio pre-processor includes at least one of: a spectral analyzer for frequency domain representation, a speech activity detector for selective processing, an audio segmenter for variable-length inputs, and a normalizer for consistent input levels.

In an aspect of an embodiment, the time-frequency domain transformer includes at least one of: a short-time Fourier transform integrator, a Mel-scale frequency processor, a phase reconstruction component, and a spectrogram-based attention mechanism.

In an aspect of an embodiment, the perceptual quality assessor implements at least one of: a psychoacoustic model that weights reconstruction based on human auditory perception, a Perceptual Evaluation of Speech Quality (PESQ) integrator, formant preservation metrics for speech clarity, and temporal structure preservation mechanisms.

### BRIEF DESCRIPTION OF THE DRAWING FIGURES

FIG. 1 is a block diagram illustrating an exemplary system architecture for upsampling of decompressed data after lossy compression using a neural network, according to an embodiment.

FIGS. 2A and 2B illustrate an exemplary architecture for an AI deblocking network configured to provide deblocking on dual-channel data stream comprising SAR I/Q data, according to an embodiment.

FIG. 3 is a block diagram illustrating an exemplary architecture for a component of the system for SAR image compression, the channel-wise transformer.

FIG. 4 is a block diagram illustrating an exemplary system architecture for providing lossless data compaction, according to an embodiment.

FIG. 5 is a diagram showing an embodiment of one aspect of the lossless data compaction system, specifically data deconstruction engine.

FIG. 6 is a diagram showing an embodiment of another aspect of lossless data compaction system 600, specifically data reconstruction engine.

FIG. 7 is a diagram showing an embodiment of another aspect of lossless data compaction the system 700, specifically library manager.

FIG. 8 is a flow diagram illustrating an exemplary method for complex-valued SAR image compression, according to an embodiment.

FIG. 9 is a flow diagram illustrating and exemplary method for decompression of a complex-valued SAR image, according to an embodiment.

FIG. 10 is a flow diagram illustrating an exemplary method for deblocking using a trained deep learning algorithm, according to an embodiment.

FIGS. 11A and 11B illustrate an exemplary architecture for an AI deblocking network configured to provide deblocking for a general N-channel data stream, according to an embodiment.

FIG. 12 is a block diagram illustrating an exemplary system architecture for N-channel data compression with predictive recovery, according to an embodiment.

FIG. 13 is a flow diagram illustrating an exemplary method for processing a compressed n-channel bit stream using an AI deblocking network, according to an embodiment.

FIG. 14 is a block diagram illustrating a system for training a neural network to perform upsampling of decompressed data after lossy compression, according to an embodiment.

FIG. 15 is a flow diagram illustrating an exemplary method for training a neural network to perform upsampling of decompressed data after lossy compression, according to an embodiment.

FIG. 16 is a flow diagram illustrating an exemplary method for performing neural upsampling of two or more audio data streams, according to an embodiment.

FIG. 17 is a block diagram illustrating exemplary architecture of audio upsampler.

FIG. 18 is a method diagram illustrating the training method for audio-specific neural upsampler of audio upsampler system.

FIG. 19 is a method diagram illustrating the audio signal processing flow through audio upsampler system.

FIG. 20 is a method diagram illustrating the multi-channel audio integration method for audio upsampler system.

FIG. 21 is a method diagram illustrating the adaptive processing method based on audio content for audio upsampler system.

FIG. 22 illustrates an exemplary computing environment on which an embodiment described herein may be implemented, in full or in part.

### DETAILED DESCRIPTION OF THE INVENTION

The inventor has conceived and reduced to practice a system and methods for upsampling of decompressed audio data after lossy compression using a neural network that integrates AI-based techniques to restore lost information and enhance perceptual audio quality. The system includes an audio-specific neural upsampler that applies specialized deep learning methods, such as convolutional layers for extracting temporal patterns, recurrent layers for modeling sequential dependencies, and a multi-channel transformer employing attention mechanisms optimized for phonetic structures. Additionally, a time-frequency domain transformer is introduced to refine spectral resolution and phase consistency using short-time Fourier transforms and Mel-scale frequency processing. A perceptual quality assessor further evaluates and optimizes reconstructed audio by leveraging psychoacoustic models, ensuring that restored audio signals align with human auditory perception.

The processing of audio data presents unique challenges compared to image and video compression. Audio signals consist of highly time-dependent structures, where fine temporal details contribute significantly to intelligibility and quality. Standard lossy audio compression techniques such as MP3, AAC, and Opus operate by discarding information deemed less perceptually relevant, often resulting in the loss of high-frequency components, unnatural phase distortions, and compression artifacts such as pre-echo and quantization noise. While these methods achieve high compression efficiency, they introduce degradations that affect speech clarity and musical fidelity, particularly at lower bitrates.

Existing approaches for improving audio quality after compression rely on heuristic post-processing techniques or traditional signal processing filters. These methods provide limited improvements and fail to recover lost information effectively. Recently, deep learning-based methods have been introduced to address this issue by learning complex relationships in audio signals from high-quality datasets. However, current deep learning models remain constrained by high computational requirements and suboptimal perceptual performance. M any models focus on mathematical accuracy rather than perceived audio quality, leading to reconstructions that may be technically correct but not subjectively pleasing. Furthermore, existing neural upsampling techniques for images and video do not directly translate to audio due to fundamental differences in data structure and perceptual importance.

According to various embodiments, a system is proposed that provides a novel pipeline for restoring lost information in audio signals after lossy compression. This system integrates multiple components designed specifically for audio processing. An audio pre-processor extracts spectral information, detects speech activity, segments the audio into appropriate processing units, and normalizes input levels to ensure consistency across different input signals. A neural upsampler then applies deep learning-based reconstruction techniques, leveraging convolutional and recurrent network layers alongside a multi-channel transformer. This architecture enables both local and global feature extraction, capturing dependencies within and across audio channels to enhance restoration accuracy.

A time-frequency domain transformer further refines the reconstructed audio by applying short-time Fourier transform processing, Mel-scale frequency enhancement, and phase reconstruction techniques. These operations ensure that the recovered audio maintains natural spectral characteristics and phase coherence, preventing artifacts such as phasiness or unnatural transients. Finally, a perceptual quality assessor evaluates the restored signal based on human auditory perception models. This component incorporates psychoacoustic principles, including perceptual weighting of spectral components, formant preservation for speech clarity, and structural integrity analysis for musical and environmental sounds.

The system and methods described herein may be applied to various types of audio data, including speech signals, music, and multi-channel audio streams. Speech data presents unique challenges due to the need for high intelligibility and speaker identity preservation. In applications such as telecommunications, voice assistants, and real-time communications, the ability to reconstruct compressed speech accurately can significantly improve user experience. The system is designed to operate efficiently in real-time or near real-time environments, making it suitable for deployment in streaming platforms, communication networks, and assistive listening devices.

According to an embodiment, the system may be utilized for multi-channel audio processing, such as stereo or surround sound reconstruction. In multi-channel environments, the correlation between channels provides additional information that can be leveraged for improved reconstruction accuracy. The neural upsampler incorporates cross-channel attention mechanisms that learn spatial and spectral relationships between audio channels, preserving the original spatial imaging and depth perception of the soundstage.

In another embodiment, the system may be adapted for speech enhancement in low-bitrate voice transmission applications. Telecommunications networks frequently employ low-bitrate codecs that introduce significant degradation to speech signals. The proposed system can be trained on paired high-quality and compressed speech datasets to learn effective reconstruction strategies, restoring clarity and naturalness to transmitted voice data.

The described system builds upon prior advances in neural upsampling while introducing novel techniques specifically optimized for audio. By integrating deep learning-based feature extraction, time-frequency domain refinement, and perceptual assessment, the system achieves high-quality audio reconstruction that surpasses existing post-processing and enhancement methods. These improvements enable more efficient use of bandwidth while maintaining superior audio fidelity, addressing critical challenges in modern audio compression and transmission applications.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. A Iso, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data set” refers to a grouping of data for a particular purpose. One example of a data set might be a word processing file containing text and formatting information. Another example of a data set might comprise data gathered/generated as the result of one or more radars in operation.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

The term “deblocking” as used herein refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames. A primary goal of deblocking is to enhance the perceptual quality of the compressed content, making it more visually appealing to viewers. It's important to note that deblocking is just one of many post-processing steps applied during the decoding and playback of compressed images and videos to improve their quality.

### Conceptual Architecture

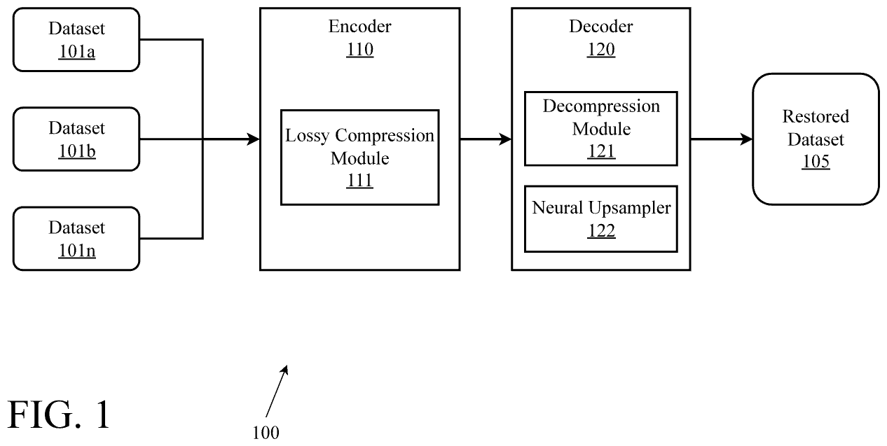

FIG. 1 is a block diagram illustrating an exemplary system architecture 100 for upsampling of decompressed data after lossy compression using a neural network, according to an embodiment. According to the embodiment, the system 100 comprises an encoder module 110 configured to receive two or more datasets 101a-n which are substantially correlated and perform lossy compression on the received dataset, and a decoder module 120 configured to receive a compressed bit stream and use a trained neural network to output a reconstructed dataset which can restore most of the “lost” data due to the lossy compression. Datasets 101a-n may comprise streaming data or data received in a batch format. Datasets 101a-n may comprise one or more datasets, data streams, data files, or various other types of data structures which may be compressed. Furthermore, dataset 101a-n may comprise n-channel data comprising a plurality of data channels sent via a single data stream.

Encoder 110 may utilize a lossy compression module 111 to perform lossy compression on a received dataset 101a-n. The type of lossy compression implemented by lossy compression module 111 may be dependent upon the data type being processed. For example, for SAR imagery data, High Efficiency Video Coding (HEVC) may be used to compress the dataset. In another example, if the data being processed is time-series data, then delta encoding may be used to compress the dataset. The encoder 110 may then send the compressed data as a compressed data stream to a decoder 120 which can receive the compressed data stream and decompress the data using a decompression module 121.

The decompression module 121 may be configured to perform data decompression a compressed data stream using an appropriate data decompression algorithm. The decompressed data may then be used as input to a neural upsampler 122 which utilizes a trained neural network to restore the decompressed data to nearly its original state 105 by taking advantage of the information embedded in the correlation between the two or more datasets 101a-n.

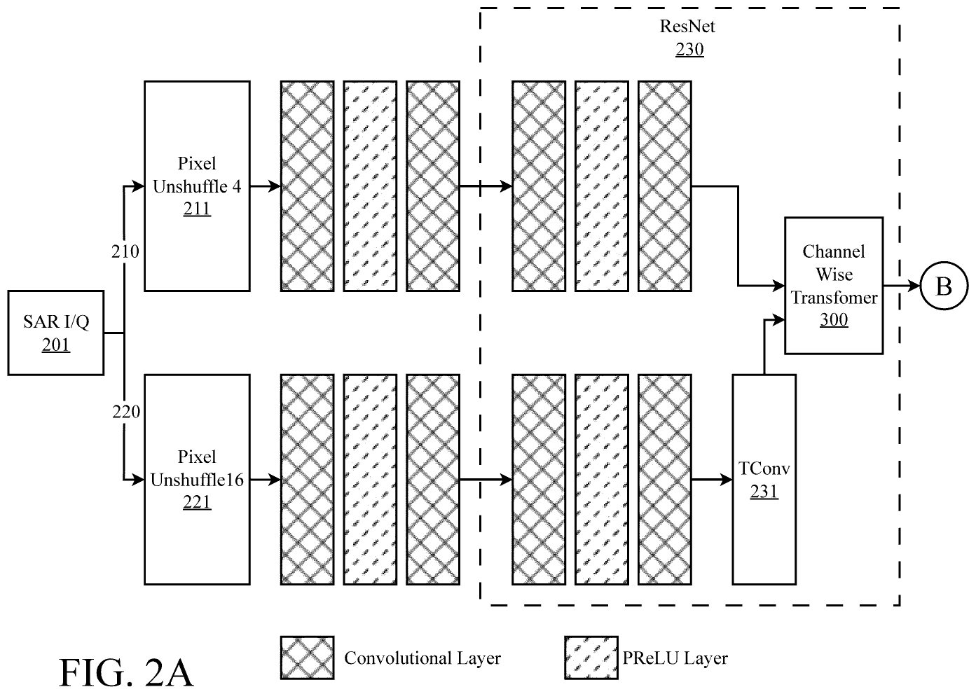

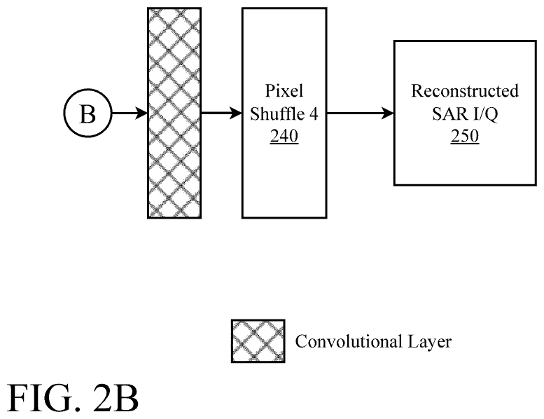

FIGS. 2A and 2B illustrate an exemplary architecture for an AI deblocking network configured to provide deblocking for dual-channel data stream comprising SAR I/Q data, according to an embodiment. In the context of this disclosure, dual-channel data refers to fact that SAR image signal can be represented as two (dual) components (i.e., I and Q) which are correlated to each other in some manner. In the case of I and Q, their correlation is that they can be transformed into phase and amplitude information and vice versa. AI deblocking network utilizes a deep learned neural network architecture for joint frequency and pixel domain learning. According to the embodiment, a network may be developed for joint learning across one or more domains. As shown, the top branch 210 is associated with the pixel domain learning and the bottom branch 220 is associated with the frequency domain learning. According to the embodiment, the AI deblocking network receives as input complex-valued SAR image I and Q channels 201 which, having been encoded via encoder 110, has subsequently been decompressed via decoder 120 before being passed to AI deblocking network for image enhancement via artifact removal. Inspired by the residual learning network and the MSAB attention mechanism, AI deblocking network employs resblocks that take two inputs. In some implementations, to reduce complexity the spatial resolution may be downsampled to one-half and one-fourth. During the final reconstruction the data may be upsampled to its original resolution. In one implementation, in addition to downsampling, the network employs deformable convolution to extract initial features, which are then passed to the resblocks. In an embodiment, the network comprises one or more resblocks and one or more convolutional filters. In an embodiment, the network comprises 8 resblocks and 64 convolutional filters.

Deformable convolution is a type of convolutional operation that introduces spatial deformations to the standard convolutional grid, allowing the convolutional kernel to adaptively sample input features based on the learned offsets. It's a technique designed to enhance the modeling of spatial relationships and adapt to object deformations in computer vision tasks. In traditional convolutional operations, the kernel's positions are fixed and aligned on a regular grid across the input feature map. This fixed grid can limit the ability of the convolutional layer to capture complex transformations, non-rigid deformations, and variations in object appearance. Deformable convolution aims to address this limitation by introducing the concept of spatial deformations. Deformable convolution has been particularly effective in tasks like object detection and semantic segmentation, where capturing object deformations and accurately localizing object boundaries are important. By allowing the convolutional kernels to adaptively sample input features from different positions based on learned offsets, deformable convolution can improve the model's ability to handle complex and diverse visual patterns.

According to an embodiment, the network may be trained as a two stage process, each utilizing specific loss functions. During the first stage, a mean squared error (MSE) function is used in the I/Q domain as a primary loss function for the AI deblocking network. The loss function of the SAR I/Q channel L_{SAR} is defined as:

$${L}_{S A R} = 𝔼 [ {‖ I - {I}_{a m p} ‖}_{2} ]$$

Moving to the second stage, the network reconstructs the amplitude component and computes the amplitude loss using MSE as follows:

$${L}_{a m p} = 𝔼 [ {‖ {I}_{a m p} - {I}_{d e c , a m p} ‖}_{2} ]$$

To calculate the overall loss, the network combines the SAR loss and the amplitude loss, incorporating a weighting factor, α, for the amplitude loss. The total loss is computed as:

$${L}_{t o t a l} = {L}_{S A R} + α \times {L}_{a m p}$$

The weighting factor value may be selected based on the dataset used during network training. In an embodiment, the network may be trained using two different SAR datasets: the National Geospatial-Intelligence Agency (NGA) SAR dataset and the Sandia National Laboratories Mini SAR Complex Imagery dataset, both of which feature complex-valued SAR images. In an embodiment, the weighting factor is set to 0.0001 for the NGA dataset and 0.00005 for the Sandia dataset. By integrating both the SAR and amplitude losses in the total loss function, the system effectively guides the training process to simultaneously address the removal of the artifacts and maintain the fidelity of the amplitude information. The weighting factor, α, enables AI deblocking network to balance the importance of the SAR loss and the amplitude loss, ensuring comprehensive optimization of the network during the training stages. In some implementations, diverse data augmentation techniques may be used to enhance the variety of training data. For example, techniques such as horizontal and vertical flops and rotations may be implemented on the training dataset. In an embodiment, model optimization is performed using MSE loss and A dam optimizer with a learning rate initially set to 1×10⁻⁴ and decreased by a factor of 2 at epochs 100, 200, and 250, with a total of 300 epochs. In an implementation, the batch size is set to 256×256 with each batch containing 16 images.

Both branches first pass through a pixel unshuffling layer 211, 221 which implements a pixel unshuffling process on the input data. Pixel unshuffling is a process used in image processing to reconstruct a high-resolution image from a low-resolution image by rearranging or “unshuffling” the pixels. The process can involve the following steps, low-resolution input, pixel arrangement, interpolation, and enhancement. The input to the pixel unshuffling algorithm is a low-resolution image (i.e., decompressed, quantized SAR I/Q data). This image is typically obtained by downscaling a higher-resolution image such as during the encoding process executed by encoder 110. Pixel unshuffling aims to estimate the original high-resolution pixel values by redistributing and interpolating the low-resolution pixel values. The unshuffling process may involve performing interpolation techniques, such as nearest-neighbor, bilinear, or more sophisticated methods like bicubic or Lanczos interpolation, to estimate the missing pixel values and generate a higher-resolution image.

The output of the unshuffling layers 211, 221 may be fed into a series of layers which can include one or more convolutional layers and one or more parametric rectified linear unit (PReLU) layers. A legend is depicted for both FIG. 2A and FIG. 2B which indicates the cross hatched block represents a convolutional layer and the dashed block represents a PReLU layer. Convolution is the first layer to extract features from an input image. Convolution preserves the relationship between pixels by learning image features using small squares of input data. It is a mathematical operation that takes two inputs such as an image matrix and a filter or kernel. The embodiment features a cascaded ResNet-like structure comprising 8 ResBlocks to effectively process the input data. The filter size associated with each convolutional layer may be different. The filter size used for the pixel domain of the top branch may be different than the filter size used for the frequency domain of the bottom branch.

A PRELU layer is an activation function used in neural networks. The PRELU activation function extends the ReLU by introducing a parameter that allows the slope for negative values to be learned during training. The advantage of PReLU over ReLU is that it enables the network to capture more complex patterns and relationships in the data. By allowing a small negative slope for the negative inputs, the PReLU can learn to handle cases where the output should not be zero for all negative values, as is the case with the standard ReLU. In other implementations, other non-linear functions such as tanh or sigmoid can be used instead of PReLU.

After passing through a series of convolutional and PReLU layers, both branches enter the resnet 230 which further comprises more convolutional and PReLU layers. The frequency domain branch is slightly different than the pixel domain branch once inside ResNet 230, specifically the frequency domain is processed by a transposed convolutional (TConv) layer 231. Transposed convolutions are a type of operation used in neural networks for tasks like image generation, image segmentation, and upsampling. They are used to increase the spatial resolution of feature maps while maintaining the learned relationships between features. Transposed convolutions aim to increase spatial dimensions of feature maps, effectively “upsampling” them. This is typically done by inserting zeros (or other values) between existing values to create more space for new values.

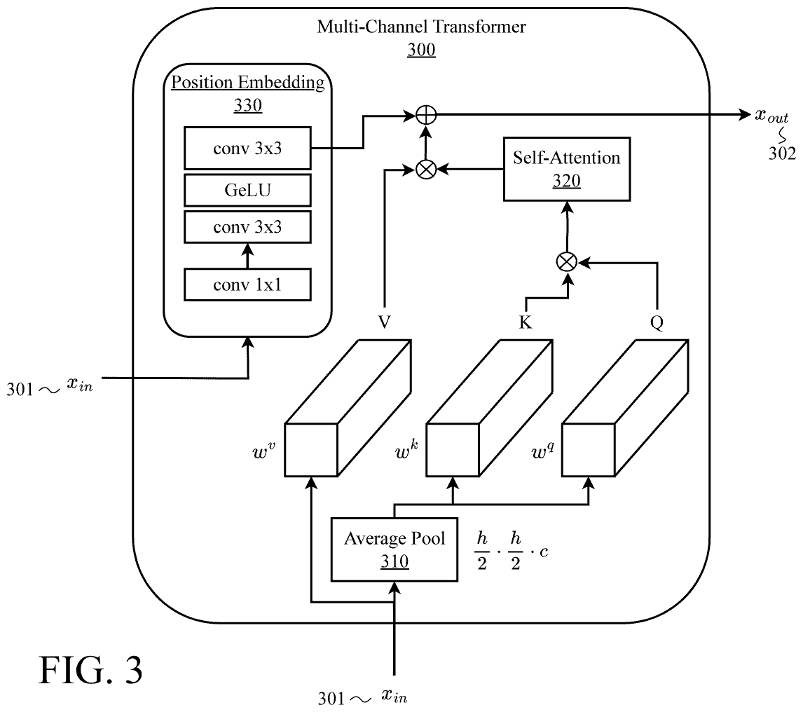

Inside ResBlock 230 the data associated with the pixel and frequency domains are combined back into a single stream by using the output of the Tconv 231 and the output of the top branch. The combined data may be used as input for a channel-wise transformer 300. In some embodiments, the channel-wise transformer may be implemented as a multi-scale attention block utilizing the attention mechanism. For more detailed information about the architecture and functionality of channel-wise transformer 300 refer to FIG. 3. The output of channel-wise transformer 300 may be a bit stream suitable for reconstructing the original SAR I/Q image. FIG. 2B shows the output of ResBlock 230 is passed through a final convolutional layer before being processed by a pixel shuffle layer 240 which can perform upsampling on the data prior to image reconstruction. The output of the AI deblocking network may be passed through a quantizer 124 for dequantization prior to producing a reconstructed SAR I/Q image 250.

FIG. 3 is a block diagram illustrating an exemplary architecture for a component of the system for SAR image compression, the channel-wise transformer 300. According to the embodiment, channel-wise transformer receives an input signal, Xin 301, the input signal comprising SAR I/Q data which is being processed by AI deblocking network 123. The input signal may be copied and follow two paths through multi-channel transformer 300.

A first path may process input data through a position embedding module 330 comprising series of convolutional layers as well as a Gaussian Error Linear Unit (GeLU). In traditional recurrent neural networks or convolutional neural networks, the order of input elements is inherently encoded through the sequential or spatial nature of these architectures. However, in transformer-based models, where the attention mechanism allows for non-sequential relationships between tokens, the order of tokens needs to be explicitly conveyed to the model.

Position embedding module 330 may represent a feedforward neural network (position-wise feedforward layers) configured to add position embeddings to the input data to convey the spatial location or arrangement of pixels in an image. The output of position embedding module 330 may be added to the output of the other processing path the received input signal is processed through.

A second path may process the input data. It may first be processed via a channel-wise configuration and then through a self-attention layer 320. The signal may be copied/duplicated such that a copy of the received signal is passed through an average pool layer 310 which can perform a downsampling operation on the input signal. It may be used to reduce the spatial dimensions (e.g., width and height) of feature maps while retaining the most important information. Average pooling functions by dividing the input feature map into non-overlapping rectangular or square regions (often referred to as pooling windows or filters) and replacing each region with the average of the values within that region. This functions to downsample the input by summarizing the information within each pooling window.

Self-attention layer 320 may be configured to provide an attention to AI deblocking network 123. The self-attention mechanism, also known as intra-attention or scaled dot-product attention, is a fundamental building block used in various deep learning models, particularly in transformer-based models. It plays a crucial role in capturing contextual relationships between different elements in a sequence or set of data, making it highly effective for tasks involving sequential or structured data like complex-valued SAR I/Q channels. Self-attention layer 320 allows each element in the input sequence to consider other elements and weigh their importance based on their relevance to the current element. This enables the model to capture dependencies between elements regardless of their positional distance, which is a limitation in traditional sequential models like RNNs and LSTMs.

The input 301 and downsampled input sequence is transformed into three different representations: Query (Q), Key (K), and Value (V). These transformations (W^{V}, W^{K}, and W^{Q}) are typically linear projections of the original input. For each element in the sequence, the dot product between its Query and the Keys of all other elements is computed. The dot products are scaled by a factor to control the magnitude of the attention scores. The resulting scores may be normalized using a softmax function to get attention weights that represent the importance of each element to the current element. The Values (V) of all elements are combined using the attention weights as coefficients. This produces a weighted sum, where elements with higher attention weights contribute more to the final representation of the current element. The weighted sum is the output of the self-attention mechanism for the current element. This output captures contextual information from the entire input sequence.

The output of the two paths (i.e., position embedding module 330 and self-attention layer 320) may be combined into a single output data stream xₒᵤₜ 302.

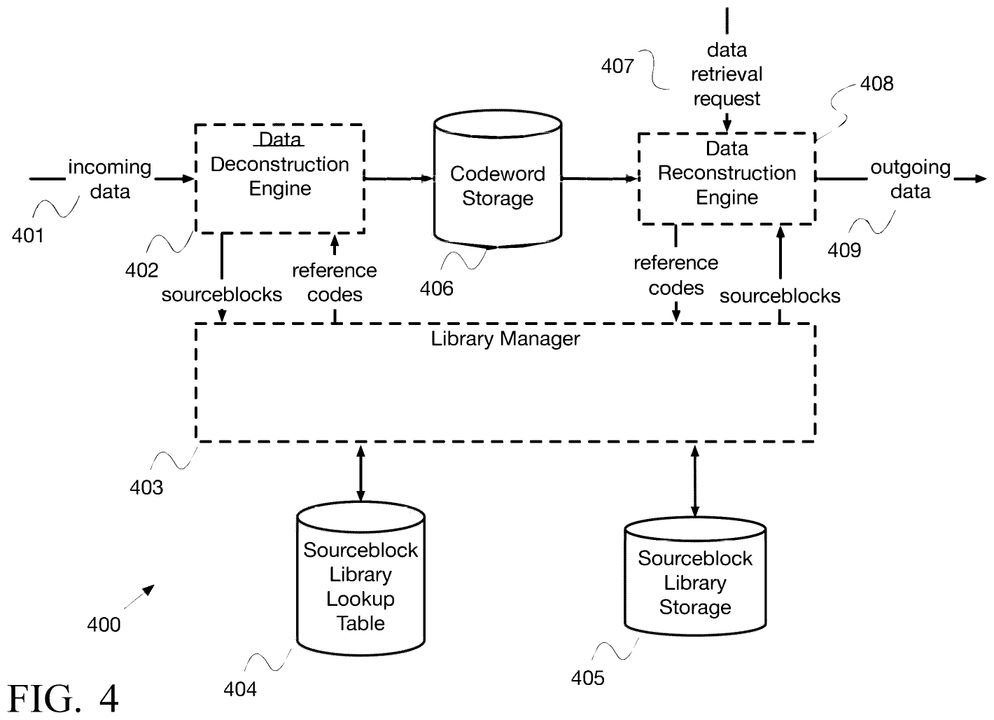

FIG. 4 is a block diagram illustrating an exemplary system architecture 400 for providing lossless data compaction, according to an embodiment. As incoming data 401 is received by data deconstruction engine 402. Data deconstruction engine 402 breaks the incoming data into sourceblocks, which are then sent to library manager 403. Using the information contained in sourceblock library lookup table 404 and sourceblock library storage 405, library manager 403 returns reference codes to data deconstruction engine 402 for processing into codewords, which are stored in codeword storage 106. When a data retrieval request 407 is received, data reconstruction engine 408 obtains the codewords associated with the data from codeword storage 406, and sends them to library manager 403. Library manager 403 returns the appropriate sourceblocks to data reconstruction engine 408, which assembles them into the proper order and sends out the data in its original form 409.

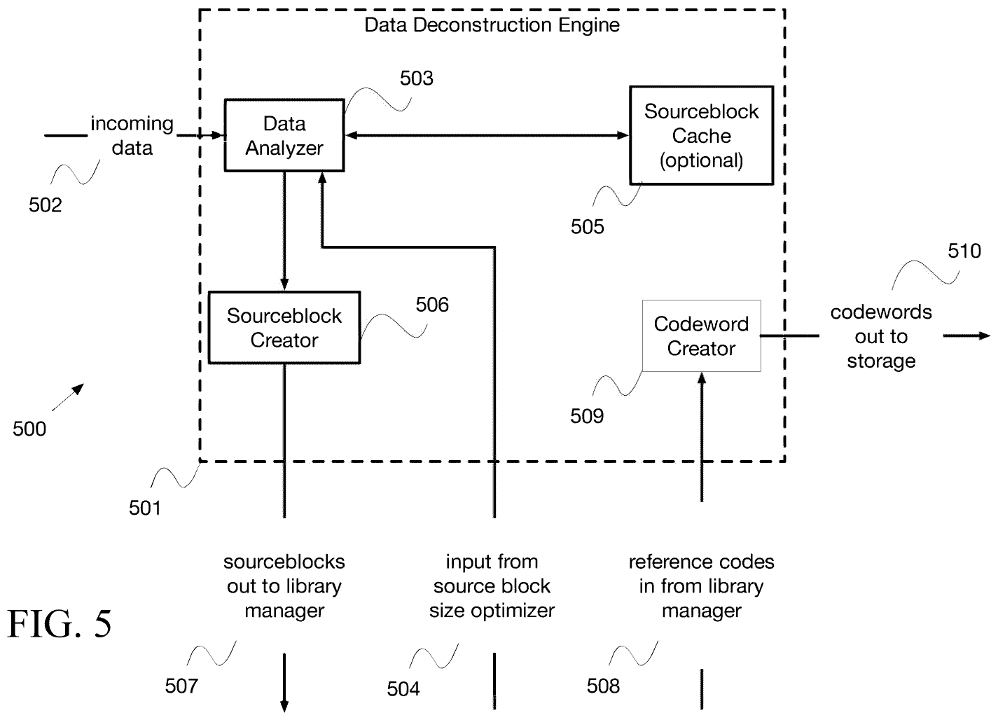

FIG. 5 is a diagram showing an embodiment of one aspect 500 of the system, specifically data deconstruction engine 501. Incoming data 502 is received by data analyzer 503, which optimally analyzes the data based on machine learning algorithms and input 504 from a sourceblock size optimizer, which is disclosed below. Data analyzer may optionally have access to a sourceblock cache 505 of recently processed sourceblocks, which can increase the speed of the system by avoiding processing in library manager 403. Based on information from data analyzer 503, the data is broken into sourceblocks by sourceblock creator 506, which sends sourceblocks 507 to library manager 403 for additional processing. Data deconstruction engine 501 receives reference codes 508 from library manager 403, corresponding to the sourceblocks in the library that match the sourceblocks sent by sourceblock creator 506, and codeword creator 509 processes the reference codes into codewords comprising a reference code to a sourceblock and a location of that sourceblock within the data set. The original data may be discarded, and the codewords representing the data are sent out to storage 510.

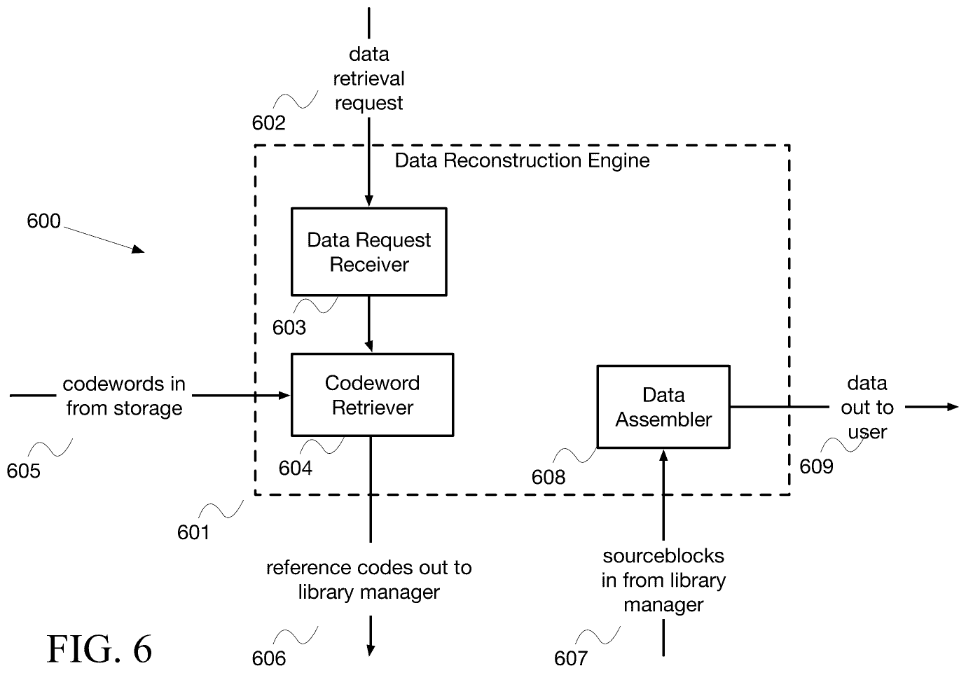

FIG. 6 is a diagram showing an embodiment of another aspect of system 600, specifically data reconstruction engine 601. When a data retrieval request 602 is received by data request receiver 603 (in the form of a plurality of codewords corresponding to a desired final data set), it passes the information to data retriever 604, which obtains the requested data 605 from storage. Data retriever 604 sends, for each codeword received, a reference codes from the codeword 606 to library manager 403 for retrieval of the specific sourceblock associated with the reference code. Data assembler 608 receives the sourceblock 607 from library manager 403 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 609 in its original form.

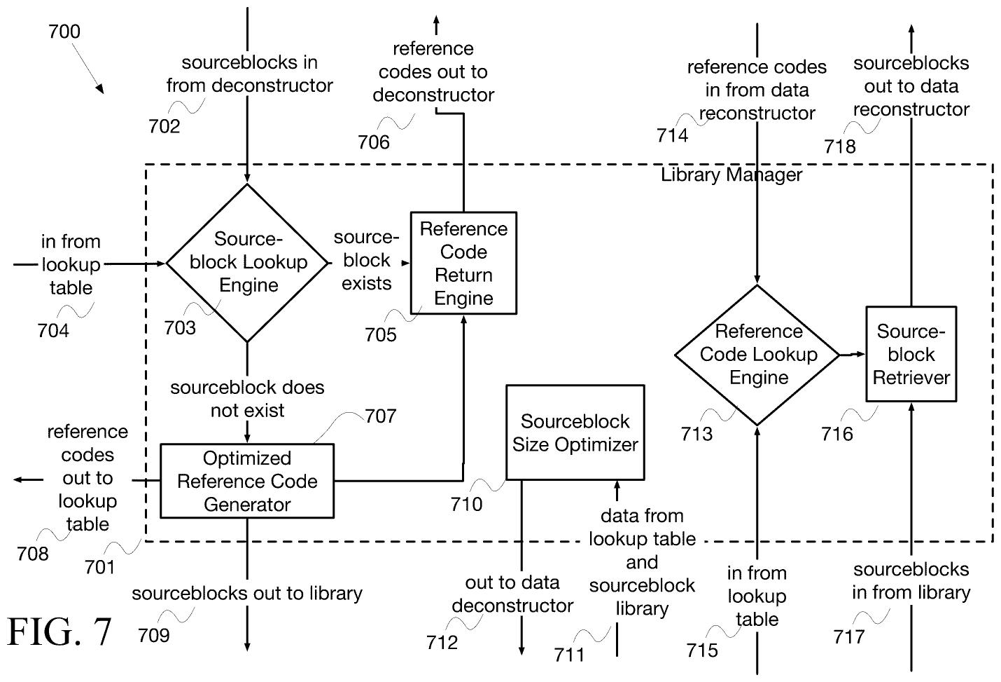

FIG. 7 is a diagram showing an embodiment of another aspect of the system 700, specifically library manager 701. One function of library manager 701 is to generate reference codes from sourceblocks received from data deconstruction engine 701. As sourceblocks are received 702 from data deconstruction engine 501, sourceblock lookup engine 703 checks sourceblock library lookup table 704 to determine whether those sourceblocks already exist in sourceblock library storage 705. If a particular sourceblock exists in sourceblock library storage 105, reference code return engine 705 sends the appropriate reference code 706 to data deconstruction engine 601. If the sourceblock does not exist in sourceblock library storage 105, optimized reference code generator 407 generates a new, optimized reference code based on machine learning algorithms. Optimized reference code generator 707 then saves the reference code 708 to sourceblock library lookup table 704; saves the associated sourceblock 709 to sourceblock library storage 105; and passes the reference code to reference code return engine 705 for sending 706 to data deconstruction engine 501. Another function of library manager 701 is to optimize the size of sourceblocks in the system. Based on information 711 contained in sourceblock library lookup table 404, sourceblock size optimizer 410 dynamically adjusts the size of sourceblocks in the system based on machine learning algorithms and outputs that information 712 to data analyzer 603. Another function of library manager 701 is to return sourceblocks associated with reference codes received from data reconstruction engine 601. As reference codes are received 714 from data reconstruction engine 601, reference code lookup engine 713 checks sourceblock library lookup table 715 to identify the associated sourceblocks; passes that information to sourceblock retriever 716, which obtains the sourceblocks 717 from sourceblock library storage 405; and passes them 718 to data reconstruction engine 601.

### Detailed Description of Exemplary Aspects

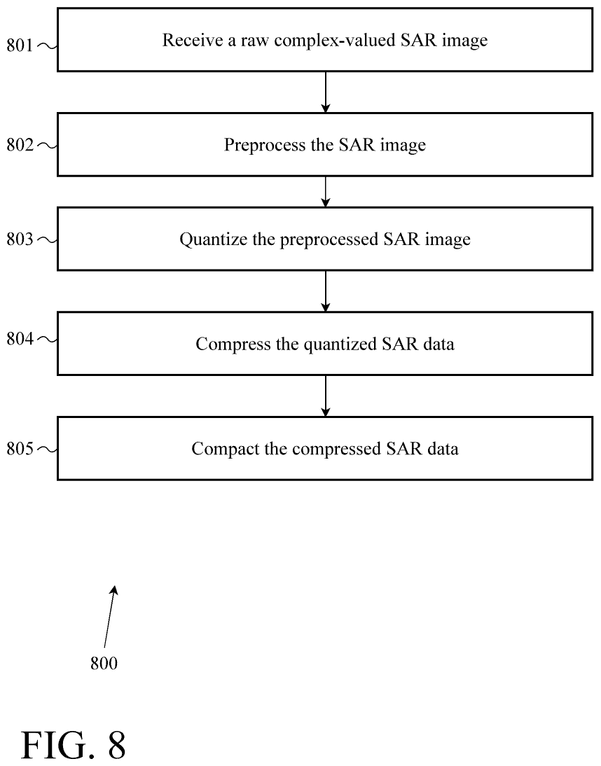

FIG. 8 is a flow diagram illustrating an exemplary method 800 for complex-valued SAR image compression, according to an embodiment. According to the embodiment, the process begins at step 801 when encoder 110 receives a raw complex-valued SAR image. The complex-valued SAR image comprises both I and Q components. In some embodiments, the I and Q components may be processed as separate channels. At step 802, the received SAR image may be preprocessed for further processing by encoder 110. For example, the input image may be clipped or otherwise transformed in order to facilitate further processing. As a next step 803, the preprocessed data may be passed to quantizer 112 which quantizes the data. The next step 804, comprises compressing the quantized SAR data using a compression algorithm known to those with skill in the art. In an embodiment, the compression algorithm may comprise HEVC encoding for both compression and decompression of SAR data. As a last step 805, the compressed data may be compacted. The compaction may be a lossless compaction technique, such as those described with reference to FIGS. 4-7. The output of method 800 is a compressed, compacted bit stream of SAR image data which can be stored in a database, requiring much less storage space than would be required to store the original, raw SAR image. The compressed and compacted bit stream may be transmitted to an endpoint for storage or processing. Transmission of the compressed and compacted data require less bandwidth and computing resources than transmitting raw SAR image data.

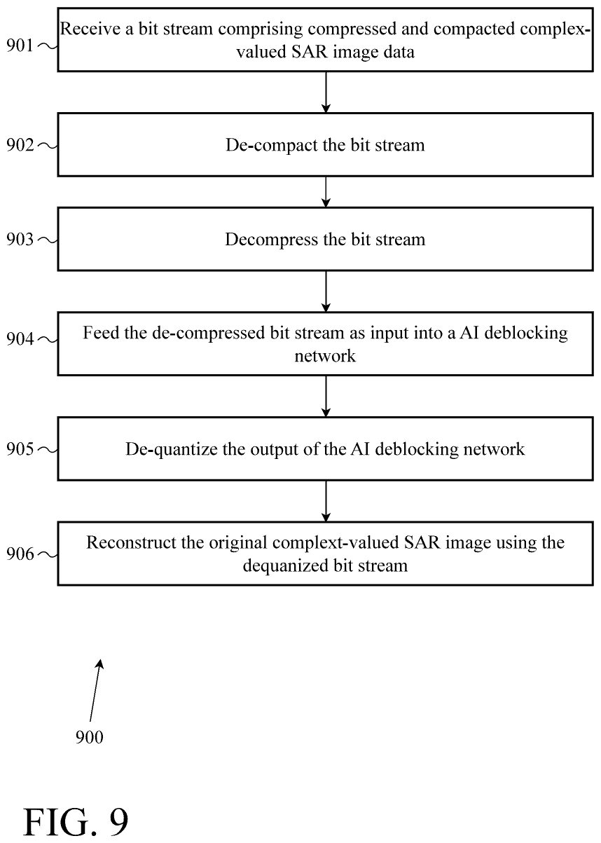

FIG. 9 is a flow diagram illustrating and exemplary method 900 for decompression of a complex-valued SAR image, according to an embodiment. According to the embodiment, the process begins at step 901 when decoder 120 receives a bit stream comprising compressed and compacted complex-valued SAR image data. The compressed bit stream may be received from encoder 110 or from a suitable data storage device. At step 902, the received bit stream is first de-compacted to produce an encoded (compressed) bit stream. In some embodiments, data reconstruction engine 601 may be implemented as a system for de-compacting a received bit stream. The next step 903, comprising decompressing the de-compacted bit stream using a suitable compression algorithm known to those with skill in the art, such as HEVC encoding. At step 904, the de-compressed SAR data may be fed as input into AI deblocking network 123 for image enhancement via a trained deep learning network. The AI deblocking network may utilize a series of convolutional layers and/or ResBlocks to process the input data and perform artifact removal on the de-compressed SAR image data. AI deblocking network may be further configured to implement an attention mechanism for the model to capture dependencies between elements regardless of their positional distance. In an embodiment, during training of AI deblocking network, the amplitude loss in conjunction with the SAR loss may be computed and accounted for, further boosting the compression performance of system 100. The output of AI deblocking network 123 can be sent to a quantizer 124 which can execute step 905 by de-quantizing the output bit stream from AI deblocking network. As a last step 906, system can reconstruct the original complex-valued SAR image using the de-quantized bit stream.

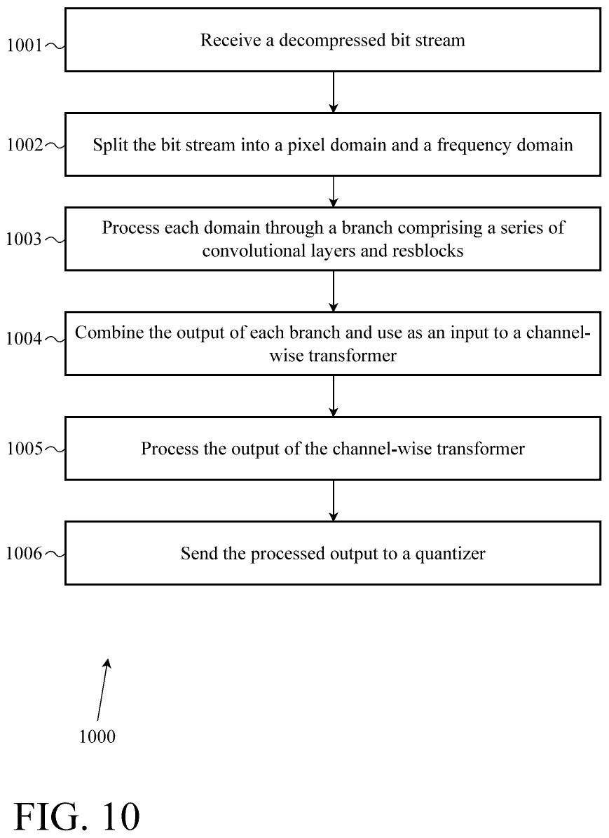

FIG. 10 is a flow diagram illustrating an exemplary method for deblocking using a trained deep learning algorithm, according to an embodiment. According to the embodiment, the process begins at step 1001 wherein the trained deep learning algorithm (i.e., AI deblocking network 123) receives a decompressed bit stream comprising SAR I/Q image data. At step 1002, the bit stream is split into a pixel domain and a frequency domain. Each domain may pass through AI deblocking network, but have separate, almost similar processing paths. As a next step 1003, each domain is processed through its respective branch, the branch comprising a series of convolutional layers and ResBlocks. In some implementations, frequency domain may be further processed by a transpose convolution layer. The two branches are combined and used as input for a multi-channel transformer with attention mechanism at step 1004. Multi-channel transformer 300 may perform functions such as downsampling, positional embedding, and various transformations, according to some embodiments. Multi-channel transformer 300 may comprise one or more of the following components: channel-wise attention, transformer self-attention, and/or feedforward layers. In an implementation, the downsampling may be performed via average pooling. As a next step 1005, the AI deblocking network processes the output of the channel-wise transformer. The processing may include the steps of passing the output through one or more convolutional or PReLU layers and/or upsampling the output. As a last step 1006, the processed output may be forwarded to quantizer 124 or some other endpoint for storage or further processing.

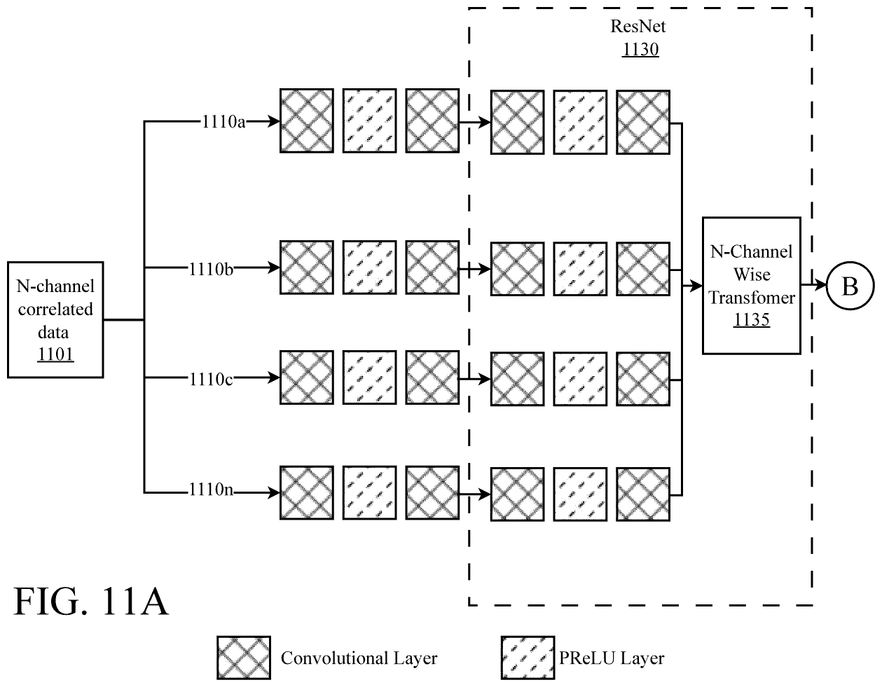

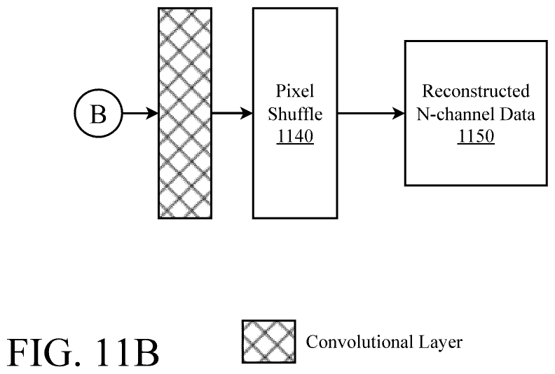

FIGS. 11A and 11B illustrate an exemplary architecture for an AI deblocking network configured to provide deblocking for a general N-channel data stream, according to an embodiment. The term “N-channel” refers to data that is composed of multiple distinct channels of modalities, where each channel represents a different aspect of type of information. These channels can exist in various forms, such as sensor readings, image color channels, or data streams, and they are often used together to provide a more comprehensive understanding of the underlying phenomenon. Examples of N-channel data include, but is not limited to, RGB images (e.g., in digital images, the red, green, and blue channels represent different color information; combining these channels allows for the representation of a wide range of colors), medical imaging (e.g., may include Magnetic Resonance Imaging scans with multiple channels representing different tissue properties, or Computed Tomography scans with channels for various types of X-ray attenuation), audio data (e.g., stereo or multi-channel audio recordings where each channel corresponds to a different microphone or audio source), radar and lidar (e.g., in autonomous vehicles, radar and lidar sensors provide multi-channel data, with each channel capturing information about objects' positions, distances, and reflectivity) SAR image data, text data (e.g., in natural language processing, N-channel data might involve multiple sources of text, such as social media posts and news articles, each treated as a separate channel to capture different textual contexts), sensor networks (e.g., environmental monitoring systems often employ sensor networks with multiple sensors measuring various parameters like temperature, humidity, air quality, and more. Each sensor represents a channel), climate data, financial data, and social network data.

The disclosed AI deblocking network may be trained to process any type of N-channel data, if the N-channel data has a degree of correlation. More correlation between and among the multiple channels yields a more robust and accurate AI deblocking network capable of performing high quality compression artifact removal on the N-channel data stream. A high degree of correlation implies a strong relationship between channels. Using SAR image data has been used herein as an exemplary use case for an AI deblocking network for a N-channel data stream comprising 2 channels, the In-phase and Quadrature components (i.e., I and Q, respectively).

Exemplary data correlations that can be exploited in various implementations of AI deblocking network can include, but are not limited to, spatial correlation, temporal correlation, cross-sectional correlation (e.g., This occurs when different variables measured at the same point in time are related to each other), longitudinal correlation, categorical correlation, rank correlation, time-space correlation, functional correlation, and frequency domain correlation, to name a few.

As shown, an N-channel AI deblocking network may comprise a plurality of branches 1110a-n. The number of branches is determined by the number of channels associated with the data stream. Each branch may initially be processed by a series of convolutional and PR eL U layers. Each branch may be processed by resnet 1130 wherein each branch is combined back into a single data stream before being input to N-channel wise transformer 1135, which may be a specific configuration of transformer 300. The output of N-channel wise transformer 1135 may be sent through a final convolutional layer before passing through a last pixel shuffle layer 1140. The output of AI deblocking network for N-channel video/image data is the reconstructed N-channel data 1150.

As an exemplary use case, video/image data may be processed as a 3-channel data stream comprising Green (G), Red (R), and Blue (B) channels. An AI deblocking network may be trained that provides compression artifact removal of video/image data. Such a network would comprise 3 branches, wherein each branch is configured to process one of the three channels (R, G, or B). For example, branch 1110a may correspond to the R-channel, branch 1110b to the G-channel, and branch 1110c to the B-channel. Each of these channels may be processed separately via their respective branches before being combined back together inside resnet 1130 prior to being processed by N-channel wise transformer 1135.

As another exemplary use case, a sensor network comprising a half dozen sensors may be processed as a 6-channel data stream. The exemplary sensor network may include various types of sensors collecting different types of, but still correlated, data. For example, sensor network can include a pressure sensor, a thermal sensor, a barometer, a wind speed sensor, a humidity sensor, and an air quality sensor. These sensors may be correlated to one another in at least one way. For example, the six sensors in the sensor network may be correlated both temporally and spatially, wherein each sensor provides a time series data stream which can be processed by one of the 6 channels 1110a-n of AI deblocking network. As long as AI deblocking network is trained on N-channel data with a high degree of correlation and which is representative of the N-channel data it will encounter during model deployment, it can reconstruct the original data using the methods described herein.

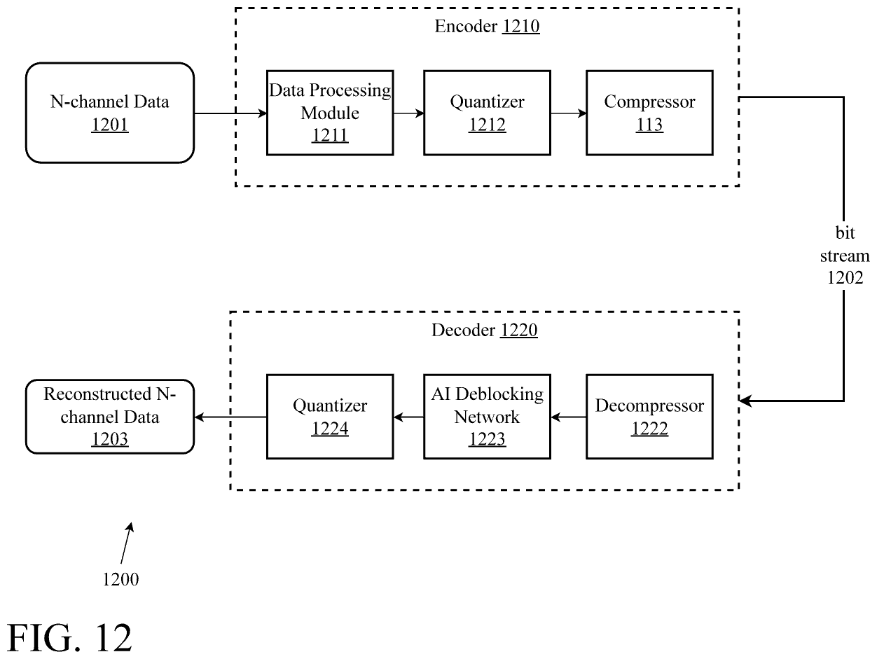

FIG. 12 is a block diagram illustrating an exemplary system architecture 1200 for N-channel data compression with predictive recovery, according to an embodiment. According to the embodiment, the system 1200 comprises an encoder module 1210 configured to receive as input N-channel data 1201 and compress and compact the input data into a bitstream 102, and a decoder module 120 configured to receive and decompress the bitstream 1202 to output a reconstructed N-channel data 1203.

A data processor module 1211 may be present and configured to apply one or more data processing techniques to the raw input data to prepare the data for further processing by encoder 1210. Data processing techniques can include (but are not limited to) any one or more of data cleaning, data transformation, encoding, dimensionality reduction, data slitting, and/or the like.

After data processing, a quantizer 1212 performs uniform quantization on the n-number of channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. Compressor 1213 may be configured to perform data compression on quantized N-channel data using a suitable conventional compression algorithm.

The resulting encoded bitstream may then be (optionally) input into a lossless compactor (not shown) which can apply data compaction techniques on the received encoded bitstream. An exemplary lossless data compaction system which may be integrated in an embodiment of system 1200 is illustrated with reference to FIG. 4-7. For example, lossless compactor may utilize an embodiment of data deconstruction engine 501 and library manager 403 to perform data compaction on the encoded bitstream. The output of the compactor is a compacted bitstream 1202 which can be stored in a database, requiring much less space than would have been necessary to store the raw N-channel data, or it can be transmitted to some other endpoint.

At the endpoint which receives the transmitted compacted bitstream 1202 may be decoder module 1220 configured to restore the compacted data into the original SAR image by essentially reversing the process conducted at encoder module 1210. The received bitstream may first be (optionally) passed through a lossless compactor which de-compacts the data into an encoded bitstream. In an embodiment, a data reconstruction engine 601 may be implemented to restore the compacted bitstream into its encoded format. The encoded bitstream may flow from compactor to decompressor 1222 wherein a data compaction technique may be used to decompress the encoded bitstream into the I/Q channels. It should be appreciated that lossless compactor components are optional components of the system, and may or may not be present in the system, dependent upon the embodiment.

According to the embodiment, an Artificial Intelligence (AI) deblocking network 1223 is present and configured to utilize a trained deep learning network to provide compression artifact removal as part of the decoding process. AI deblocking network 1223 may leverage the relationship demonstrated between the various N-channels of a data stream to enhance the reconstructed N-channel data 1203. Effectively, AI deblocking network 1223 provides an improved and novel method for removing compression artifacts that occur during lossy compression/decompression using a network designed during the training process to simultaneously address the removal of artifacts and maintain fidelity of the original N-channel data signal, ensuring a comprehensive optimization of the network during the training stages.

The output of AI deblocking network 1223 may be dequantized by quantizer 1224, restoring the n-channels to their initial dynamic range. The dequantized n-channel data may be reconstructed and output 1203 by decoder module 1220 or stored in a database.

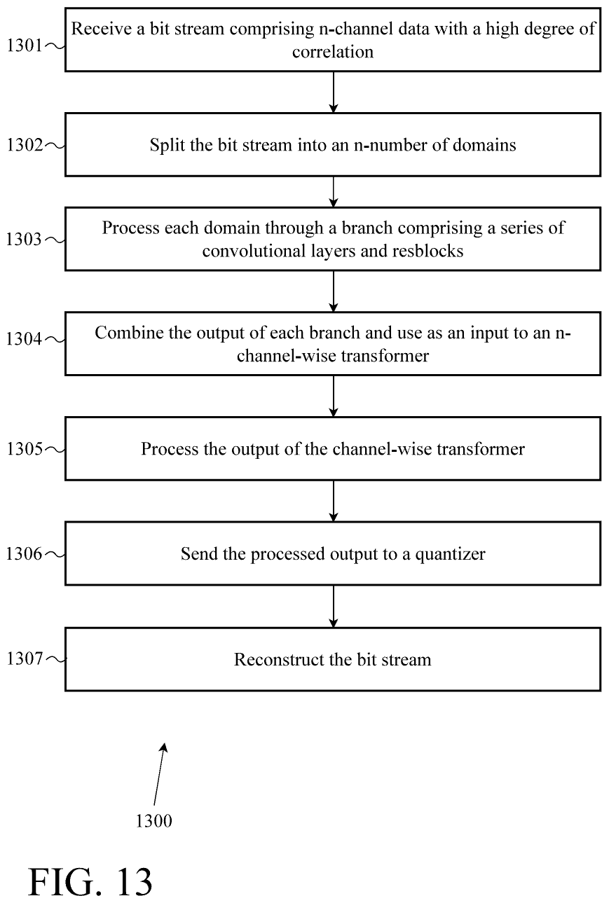

FIG. 13 is a flow diagram illustrating an exemplary method for processing a compressed n-channel bit stream using an AI deblocking network, according to an embodiment. According to the embodiment, the process begins at step 1301 when a decoder module 1220 receives, retrieves, or otherwise obtains a bit stream comprising n-channel data with a high degree of correlation. At step 1302, the bit stream is split into an n-number of domains. For example, if the received bit stream comprises image data in the form of R-, G,- and B-channels, then the bit stream would be split into 3 domains, one for each color (RGB). At step 1303, each domain is processed through a branch comprising a series of convolutional layers and ResBlocks. The number of layers and composition of said layers may depend upon the embodiment and the n-channel data being processed. At step 1304, the output of each branch is combined back into a single bitstream and used as an input into an n-channel wise transformer 1135. At step 1305, the output of the channel-wise transformer may be processed through one or more convolutional layers and/or transformation layers, according to various implementations. At step 1306, the processed output may be sent to a quantizer for upscaling and other data processing tasks. As a last step 1307, the bit stream may be reconstructed into its original uncompressed form.

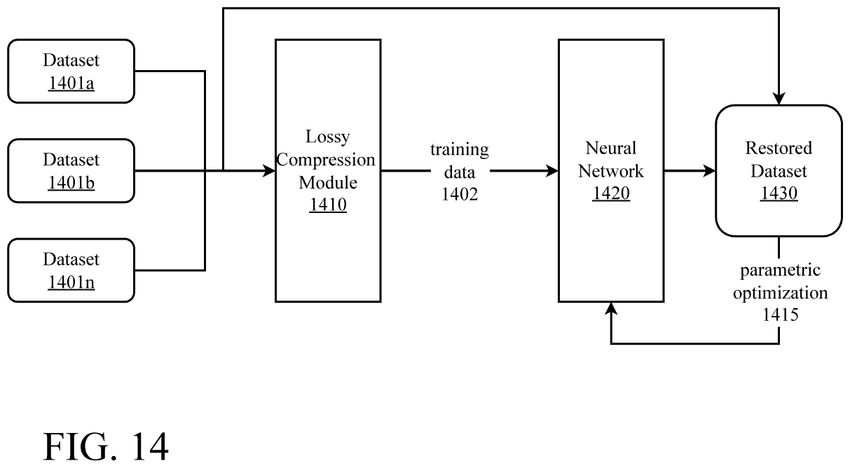

FIG. 14 is a block diagram illustrating a system for training a neural network to perform upsampling of decompressed data after lossy compression, according to an embodiment. The neural network may be referred to herein as a neural upsampler. According to the embodiment, a neural upsampler 1430 may be trained by taking training data 1402 which may comprise sets of two or more correlated datasets 101a-n and performing whatever processing that is done to compress the data. This processing is dependent upon the type of data and may be different in various embodiments of the disclosed system and methods. For example, in the SAR imagery use case, the processing and lossy compression steps used quantization and HEVC compression of the I and Q images. The sets of compressed data may be used as input training data 1402 into the neural network 1420 wherein the target output is the original uncompressed data. Because there is correlation between the two or more datasets, the neural upsampler learns how to restore “lost” data by leveraging the cross-correlations.

For each type of input data, there may be different compression techniques used, and different data conditioning for feeding into the neural upsampler. For example, if the input datasets 101a-n comprise a half dozen correlated time series from six sensors arranged on a machine, then delta encoding or a swinging door algorithm may be implemented for data compression and processing.

The neural network 1420 may process the training data 1402 to generate model training output in the form of restored dataset 1430. The neural network output may be compared against the original dataset to check the model's precision and performance. If the model output does not satisfy a given criteria or some performance threshold, then parametric optimization 1415 may occur wherein the training parameters and/or network hyperparameters may be updated and applied to the next round of neural network training.

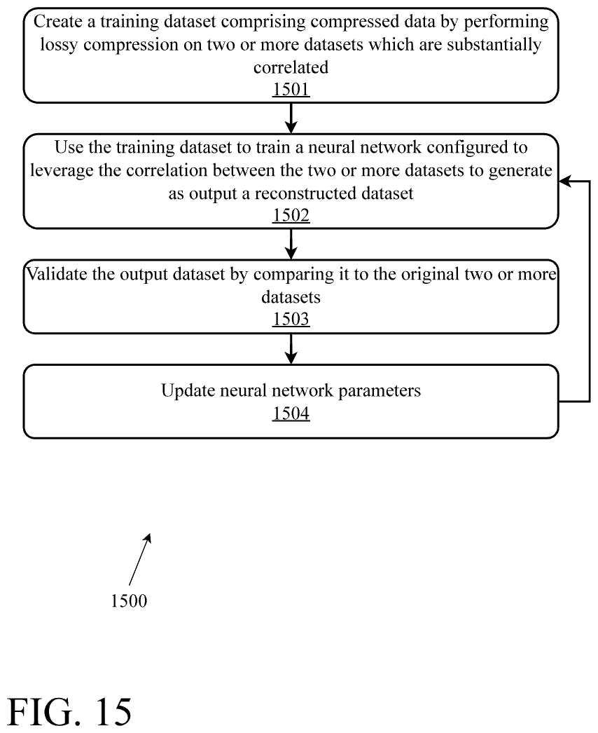

FIG. 15 is a flow diagram illustrating an exemplary method 1500 for training a neural network to perform upsampling of decompressed data after lossy compression, according to an embodiment. According to an embodiment, the process begins at step 1501 by creating a training dataset comprising compressed data by performing lossy compression on two or more datasets which are substantially correlated. As a next step 1502, the training dataset is used to train a neural network (i.e., neural upsampler) configured to leverage the correlation between the two or more datasets to generate as output a reconstructed dataset. At step 1503, the output of the neural network is compared to the original two more datasets to determine if the performance of the neural network at reconstructing the compressed data. If the model performance is not satisfactory, which may be determined by a set of criteria or some performance metric or threshold, then the neural network model parameters and/or hyperparameters may be updated 1504 and applied to the next round of training as the process moves to step 1502 and iterates through the method again.

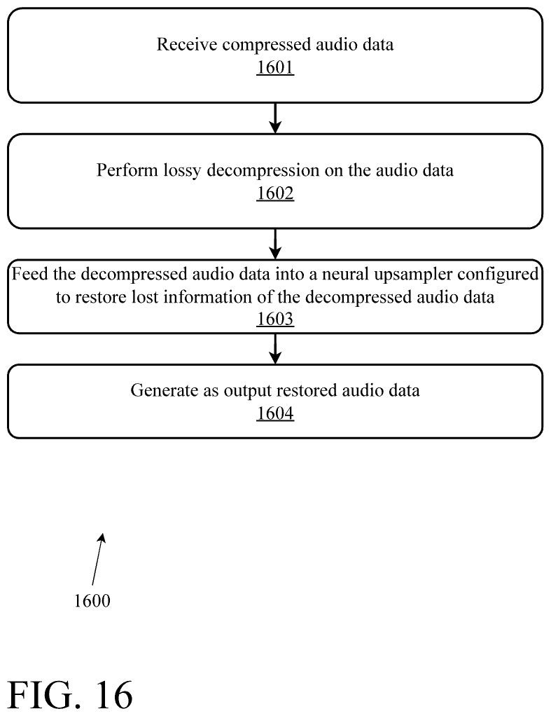

FIG. 16 is a flow diagram illustrating an exemplary method 1600 for performing neural upsampling of two or more audio data streams, according to an embodiment. In this example, the two or more audio streams may be associated with large sets of speech samples. Speech in a given language will always be somewhat correlated, wherein different factors will affect the degree of correlation between speech samples. One correlation may be affected by the actual content (number of common words) of the speech samples. For example, call center agents and callers recorded speech samples will tend to be very highly correlated. Another factor which can affect correlation of speech samples is the presence of a common language or demographics of speakers. If the samples are all associated with the same speaker, then those samples will be even more correlated. A neural upsampler which has been trained on compressed audio data associated with one or more speech channels is present and configured to restore audio data which has undergone lossy data compression and decompression by leveraging the correlation between the audio data streams. A non-exhaustive list of audio data correlations that may be used by an embodiment of the system and method can include cross-correlation, auto-correlation, phase correlation, a Pearson correlation coefficient, dynamic time warping, binaural correlation, Mel-Frequency cepstral coefficients, pitch or fundamental frequency correlation, phonetic alignment, formants correlation, spectral cross-correlation, voice activity detection correlation, and/or the like.

The two or more audio data streams may be processed by an encoder employing a lossy compression module. The lossy compression module may implement a lossy compression algorithm appropriate for compressing audio data. The choice of compression implementation may be based on various factors including, but not limited to, the type of data being processed, the computational resources and time required, and the use case of the upsampler. Exemplary audio data compression techniques which may be used include, but are not limited to, MP3, advanced audio coding, Ogg Vorbis, Opus, A C3, Musepack, and adaptive transform acoustic coding, to name a few. The compressed audio data may be store in a database and/or transmitted to an endpoint. The compressed audio data may be sent to a decoder which may employ a lossy decompression technique on the compressed audio data. The decompressed data may be sent to the neural upsampler which can restore the decompressed data to nearly its original state by leveraging the correlation between the audio data streams. The compressed audio data is received by a decoder at step 1601. At the decoder the compressed audio data may be decompressed via a lossy decompression algorithm at step 1602.

A neural upsampler for restoration of audio (e.g., speech) data received from two or more speech channels may be trained using two or more datasets comprising compressed audio data which is substantially correlated. For example, the two or more datasets may comprise audio recording data from a call center wherein one speech channel is associated with an call center agent and a second speech channel is associated with a customer. The two channels are correlated in various ways such as by the topic of the call and that they are sharing a conversation. Additionally, the background noise for each audio channel may be used to correlate the two speech channels. In an embodiment, more audio channels may be used as training data, wherein the additional audio channels are associated with other call center agents working in the same call center as the call center agent from the original dataset. In various embodiments, each channel of the received audio data may be fed into its own neural network comprising a series of convolutional and ReLU layers which can be used to learn latent correlations in the feature space that can be used to restore data which has undergone lossy compression. A multi-channel transformer may be configured to receive the output of each of the neural networks to produce, learn from the latent correlation in the feature space, and produce reconstructed audio data. At step 1603, the decompressed audio data may be used as input to the trained neural upsampler configured to restore the lost information of the decompressed audio data. The neural upsampler can process the decompressed data to generate as output restored audio data at step 1604.

### Audio Upsampler System Architecture

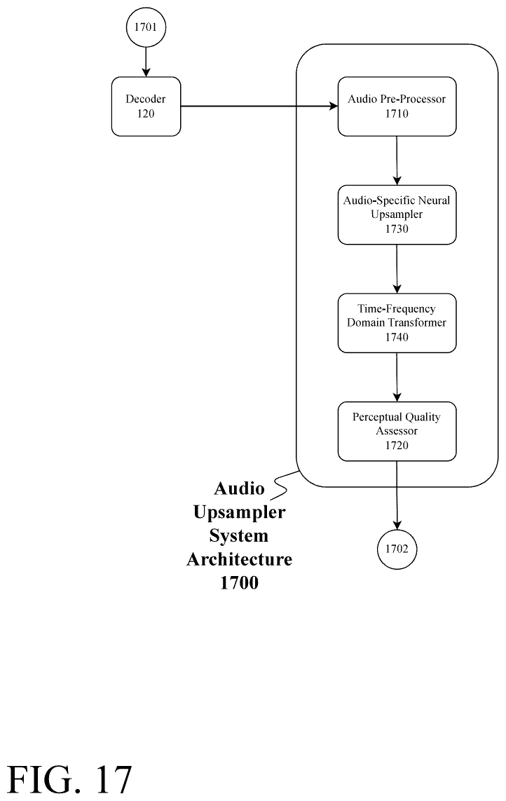

FIG. 17 is a block diagram illustrating exemplary architecture of audio upsampler system 1700, in an embodiment. According to the embodiment, audio upsampler system 1700 provides specialized processing for recovering information lost during lossy compression of audio data, particularly for speech signals. Audio upsampler system 1700 comprises audio pre-processor 1710, perceptual quality assessor 1720, audio-specific neural upsampler 1730, and time-frequency domain transformer 1740, which work together to enhance decompressed audio data.

Audio upsampler system 1700 receives compressed audio data 1701 which typically comprises two or more substantially correlated audio channels that have undergone lossy compression through encoder 110 as described in FIG. 1. Compressed audio data 1701 may consist of audio content compressed through common audio compression algorithms such as MP3, advanced audio coding (AAC), Opus, or other lossy audio compression techniques mentioned in ¶[0107] of the detailed description.

Upon receiving compressed audio data 1701, audio upsampler system 1700 initially processes this data through decoder 120 (as shown in FIG. 1) which performs standard decompression operations to generate a decompressed bitstream. This decompressed bitstream is then directed to audio pre-processor 1710, which performs several conditioning operations to prepare the audio for neural processing.

Audio pre-processor 1710 includes spectral analysis capabilities that transform time-domain audio signals into frequency-domain representations, providing richer information for subsequent processing. For example, audio pre-processor 1710 may implement various transform techniques including, but not limited to, Fast Fourier Transform (FFT), Short-Time Fourier Transform (ST FT), Discrete Wavelet Transform (DWT), or Constant-Q Transform (CQT) for spectral analysis. In an embodiment, this spectral analysis may adaptively select window sizes based on signal characteristics, using shorter windows (e.g., 10-20 ms) for transient sounds and longer windows (e.g., 40-80 ms) for more stationary sounds. Audio pre-processor 1710 also includes speech activity detection functionality that identifies segments containing speech, allowing for specialized processing on speech-containing regions. This speech activity detection may employ, for example, energy-based methods, zero-crossing rate analysis, spectral flux measurements, or machine learning approaches such as Gaussian Mixture Models (GM M s) or neural network-based classifiers. In some embodiments, the speech activity detector may be trained on diverse multilingual speech corpora including clean speech, noisy speech, and various speaking styles to ensure robust performance across different audio conditions. Training data may include public datasets such as TIM IT, LibriSpeech, or VoxCeleb, augmented with various noise types at different signal-to-noise ratios.

Audio pre-processor 1710 further segments the audio into appropriate chunks for processing and normalizes input levels to ensure consistent processing throughout the neural network stages. Segmentation strategies may include fixed-length segmentation (e.g., dividing audio into 200 ms to 2 s chunks), dynamic segmentation based on acoustic boundaries, or overlapping segments with adaptive hop sizes. Normalization techniques may include, but are not limited to, peak normalization, RMS normalization, or more sophisticated approaches such as adaptive gain control or frequency-dependent normalization that preserves dynamic range while ensuring consistent input levels. These operations help condition the decompressed audio signals before they enter the more computationally intensive neural processing stages, potentially reducing computational requirements while improving reconstruction quality.

The conditioned audio signals from audio pre-processor 1710 flow into audio-specific neural upsampler 1730, which serves as a specialized implementation of neural upsampler 122 (shown in FIG. 1) optimized for audio data. Audio-specific neural upsampler 1730 employs specialized convolutional layers designed to identify and enhance temporal patterns particularly relevant to speech and audio data. For example, these convolutional layers may include 1D temporal convolutions with various kernel sizes (e.g., ranging from 3 to 15 samples), dilated convolutions to capture longer-range dependencies without increasing parameter count, or frequency-domain convolutions that operate on spectrogram representations. In some embodiments, these convolutions may implement causal constraints to prevent information leakage from future time steps, which is important for real-time applications.

Audio-specific neural upsampler 1730 incorporates recurrent network structures that model sequence information across time, capturing dependencies important for speech intelligibility. These recurrent structures may include, for instance, Long Short-Term Memory (LSTM) networks, Gated Recurrent Units (GRUs), Quasi-Recurrent Neural Networks (QRNNs), or Temporal Convolutional Networks (TCNs) that provide efficient alternatives to traditional recurrent architectures. In an embodiment, bidirectional variants of these networks may be used for non-real-time applications to capture both past and future context. Audio-specific neural upsampler 1730 additionally utilizes attention mechanisms specifically tuned to phonetic structures found in speech, allowing the system to prioritize perceptually important aspects of the signal. These attention mechanisms may be implemented as self-attention layers similar to those in transformer architectures, cross-attention between different feature representations, or specialized audio attention modules that incorporate frequency-selective attention. The neural upsampler may be trained on paired datasets of high-quality original audio and their compressed-then-decompressed counterparts, using various compression algorithms (e.g., MP3, AAC, Opus) at different bitrates to ensure generalization across compression artifacts. Training objectives may combine traditional reconstruction losses (e.g., L1 or L2 in time or frequency domain) with perceptually-weighted losses that emphasize audibly important signal components. Audio-specific neural upsampler 1730 processes different frequency bands at multiple resolutions, recognizing that audio information has varying importance across the frequency spectrum. For instance, it may employ a multi-band architecture that divides the spectrum into sub-bands (e.g., 0-1 kHz, 1-4 kHz, 4-8 kHz, 8-16 kHz) and processes each with specialized network paths, or it may implement frequency-dependent attention mechanisms that adaptively focus on perceptually critical regions.

The output from audio-specific neural upsampler 1730 passes to time-frequency domain transformer 1740, which enhances the channel-wise transformer 300 (described in FIG. 3) with audio-specific capabilities. Time-frequency domain transformer 1740 integrates short-time Fourier transform processing to provide accurate time-frequency representations of the audio signal. In an embodiment, this ST FT processing may implement multi-resolution analysis using different window sizes simultaneously (e.g., 512, 1024, and 2048 samples) to capture both temporal precision and frequency resolution. The transformer may also implement specialized overlap-add techniques to ensure smooth transitions between processed frames. Time-frequency domain transformer 1740 includes Mel-scale frequency processing that weights frequency bands according to human perceptual sensitivity. For example, this may involve converting linear frequency spectra to Mel-scale representations using filterbanks with 40-128 bands, with greater resolution in perceptually important regions below 8 kHz. In some embodiments, alternative perceptual scales such as Bark scale or ERB (Equivalent Rectangular Bandwidth) scale may be employed depending on the specific application requirements. Time-frequency domain transformer 1740 implements phase reconstruction components that recover phase information critical for natural sound reproduction. These components may utilize techniques such as Griffin-Lim algorithm, consistency constraints in the complex domain, or dedicated phase reconstruction networks trained specifically to predict natural phase progressions from magnitude information. For example, phase reconstruction may employ a deep neural network trained on paired magnitude-phase examples extracted from high-quality speech recordings. Time-frequency domain transformer 1740 applies spectrogram-based attention mechanisms that focus processing on spectrogram regions containing the most perceptually relevant information. Such mechanisms may include, for instance, frequency-selective attention that prioritizes formant regions in speech, time-selective attention that focuses on transient events, or joint time-frequency attention that identifies patterns across both dimensions simultaneously. The transformer architecture may be pre-trained on large audio corpora and fine-tuned on domain-specific data, using self-supervised objectives such as spectrogram inpainting or audio generation tasks to learn robust representations.

The transformed audio signals then flow to perceptual quality assessor 1720, which evaluates the reconstructed audio using models aligned with human perception. Perceptual quality assessor 1720 implements psychoacoustic models that weight reconstruction accuracy based on human hearing characteristics, prioritizing frequencies and temporal features most important to perception. For example, these models may incorporate auditory masking effects where stronger signals mask weaker signals within critical bands, equal-loudness contours that reflect the frequency-dependent sensitivity of human hearing, or temporal masking where sounds can mask other sounds that occur shortly before or after them. In an embodiment, the psychoacoustic model may be implemented as a differentiable neural network component trained to predict human judgments of audio quality, allowing it to be integrated into the training process. Perceptual quality assessor 1720 incorporates Perceptual Evaluation of Speech Quality (PESQ) integration to provide standardized quality metrics for speech signals. This integration may include a differentiable approximation of the PESQ algorithm that can be used during training, or a hybrid approach that combines elements of PESQ with neural network-based quality prediction. The quality assessor may be trained on human quality judgments from listening tests conducted with diverse listener panels across different demographic groups and listening conditions. Perceptual quality assessor 1720 calculates formant preservation metrics that assess how well speech-specific resonances are maintained, which directly impacts speech clarity and intelligibility. These metrics may track formant frequencies and bandwidths across time, comparing them between the original and reconstructed signals, or employ more sophisticated measures that consider the perceptual importance of different formants in different phonetic contexts. For instance, the system may place greater emphasis on the first three formants (F1, F2, F3) which carry most of the phonetic information in speech, while also considering formant transitions which are crucial for consonant perception. Perceptual quality assessor 1720 analyzes temporal structure preservation to ensure that timing relationships critical to speech comprehension are accurately maintained. This analysis may include evaluation of envelope modulation preservation, onset timing accuracy, phoneme duration consistency, and rhythmic pattern maintenance. In some embodiments, the quality assessor may implement specialized metrics for different speech components, such as separate evaluations for vowels, consonants, and prosodic features, recognizing that different speech elements have distinct perceptual requirements and quality criteria.

The analyzed and enhanced audio is then output from audio upsampler system 1700 as reconstructed audio output 1702, which contains significantly higher quality and detail than would be possible through conventional decompression techniques alone. This audio output can maintain characteristics and information that would normally be lost in the compression-decompression process, leveraging the correlation between audio channels and learned patterns in speech to reconstruct missing information.

Audio upsampler system 1700 integrates with existing components described in the patent, particularly building upon the neural upsampling approach detailed in FIG. 14 and FIG. 15, but with specialized adaptations for audio data. Neural network training follows similar processes to those described in ¶[0102], but with audio-specific datasets and loss functions modified to incorporate perceptual audio quality metrics rather than merely using mean squared error. The system leverages the N-channel architecture described in FIGS. 11A and 11B for processing multi-channel audio such as stereo or surround sound configurations, while applying the specific audio enhancements detailed in audio upsampler system 1700.

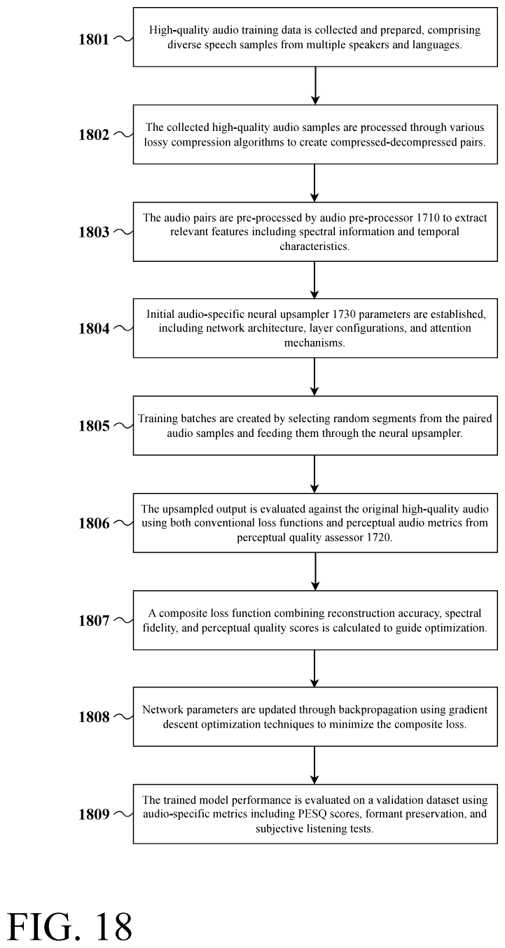

FIG. 18 is a method diagram illustrating the training method for audio-specific neural upsampler of audio upsampler system 1700, in an embodiment. High-quality audio training data is collected and prepared, comprising diverse speech samples from multiple speakers and languages across various acoustic environments, speaking styles, and recording conditions to ensure robustness and generalizability of the trained model 1801. The collected high-quality audio samples are processed through various lossy compression algorithms such as MP3, AAC, and Opus at different bitrates to create compressed-decompressed pairs that represent a range of compression artifacts and quality levels that the neural upsampler will need to address 1802. The audio pairs are pre-processed by audio pre-processor 1710 to extract relevant features including spectral information and temporal characteristics, applying techniques such as short-time Fourier transforms, Mel-spectrogram conversion, and speech activity detection to generate rich multi-dimensional representations that capture the nuances of the original and compressed audio signals 1803. Initial audio-specific neural upsampler 1730 parameters are established, including network architecture, layer configurations, and attention mechanisms, with hyperparameters selected based on preliminary experiments and domain knowledge about audio reconstruction tasks 1804. Training batches are created by selecting random segments from the paired audio samples and feeding them through the neural upsampler, ensuring diversity in training examples by including various speech sounds, compression artifacts, and acoustic conditions within each batch 1805. The upsampled output is evaluated against the original high-quality audio using both conventional loss functions such as mean squared error and L1 distance in time and frequency domains, and perceptual audio metrics from perceptual quality assessor 1720 including psychoacoustic models that weight errors according to human hearing sensitivity 1806. A composite loss function combining reconstruction accuracy, spectral fidelity, and perceptual quality scores is calculated to guide optimization, with adaptive weighting that may emphasize different aspects of audio quality depending on the content type and specific artifacts present in each sample 1807. Network parameters are updated through backpropagation using gradient descent optimization techniques to minimize the composite loss, with techniques such as A dam optimizer, learning rate scheduling, and gradient clipping employed to ensure stable and efficient training 1808. The trained model performance is evaluated on a validation dataset using audio-specific metrics including PESQ scores, formant preservation, and subjective listening tests, with refinements made to the model architecture or training process if performance does not meet predetermined quality thresholds 1809.

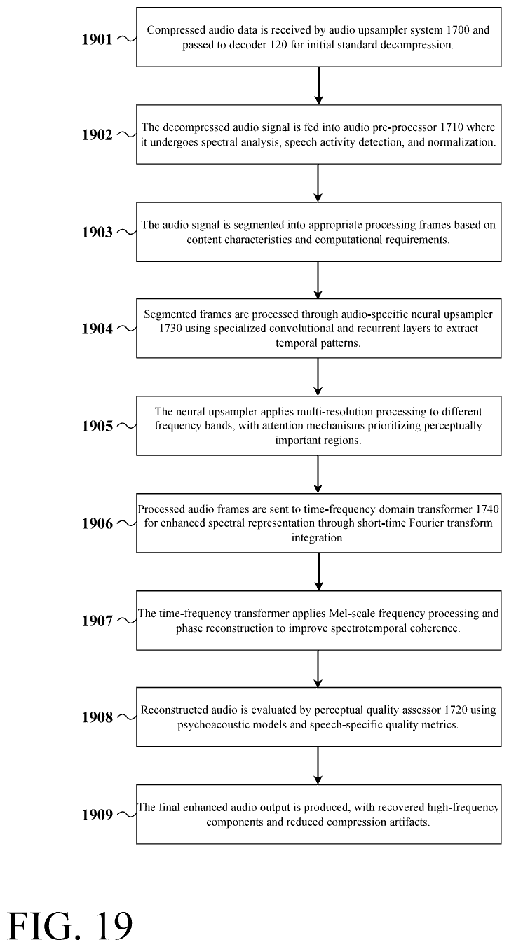

FIG. 19 is a method diagram illustrating the audio signal processing flow through audio upsampler system 1700, in an embodiment. Compressed audio data is received by audio upsampler system 1700 and passed to decoder 120 for initial standard decompression using conventional algorithms that reverse the basic compression process but cannot recover information completely lost during lossy compression 1901. The decompressed audio signal is fed into audio pre-processor 1710 where it undergoes spectral analysis using transform techniques to convert time-domain signals into frequency representations, speech activity detection to identify regions containing vocal content, and normalization to ensure consistent signal levels throughout processing 1902. The audio signal is segmented into appropriate processing frames based on content characteristics and computational requirements, with segment boundaries potentially aligned with speech phonemes or acoustic transitions to preserve natural boundaries in the signal 1903. Segmented frames are processed through audio-specific neural upsampler 1730 using specialized convolutional and recurrent layers to extract temporal patterns, where the convolutional operations capture local spectrotemporal features while the recurrent connections model longer-term dependencies crucial for speech intelligibility 1904. The neural upsampler applies multi-resolution processing to different frequency bands, with attention mechanisms prioritizing perceptually important regions such as formant structures in speech, employing greater computational resources on bands that contribute more significantly to perceived quality 1905. Processed audio frames are sent to time-frequency domain transformer 1740 for enhanced spectral representation through short-time Fourier transform integration, which provides high-resolution time-frequency analysis crucial for accurate audio reconstruction 1906. The time-frequency transformer applies Mel-scale frequency processing that weights frequency bands according to human hearing sensitivity and implements phase reconstruction techniques to recover natural phase relationships that are typically lost during compression but essential for audio fidelity 1907. Reconstructed audio is evaluated by perceptual quality assessor 1720 using psychoacoustic models and speech-specific quality metrics, with potential adjustments applied based on this assessment to optimize perceived quality rather than simply minimizing mathematical error 1908. The final enhanced audio output is produced, with recovered high-frequency components and reduced compression artifacts, resulting in audio that exhibits significantly improved clarity, naturalness, and detail compared to conventional decompression alone 1909.

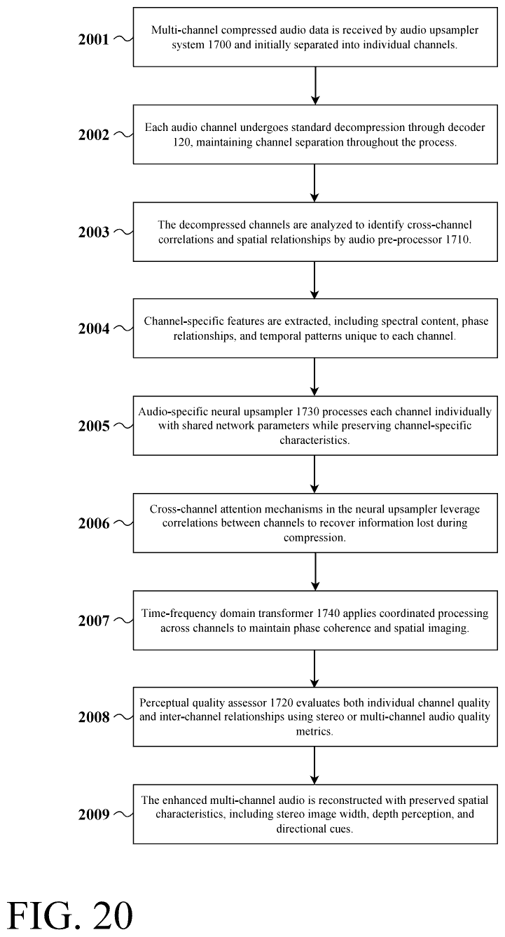

FIG. 20 is a method diagram illustrating the multi-channel audio integration method for audio upsampler system 1700, in an embodiment. Multi-channel compressed audio data is received by audio upsampler system 1700 and initially separated into individual channels, allowing for both individual channel processing and cross-channel analysis 2001. Each audio channel undergoes standard decompression through decoder 120, maintaining channel separation throughout the process while preserving the relative timing and alignment between channels that is crucial for spatial audio perception 2002. The decompressed channels are analyzed to identify cross-channel correlations and spatial relationships by audio pre-processor 1710, which may include interchannel phase difference analysis, correlation coefficient calculation, and spatial feature extraction to establish how information is distributed across the channels 2003. Channel-specific features are extracted, including spectral content, phase relationships, and temporal patterns unique to each channel, while also identifying shared acoustic elements that appear across multiple channels with different characteristics due to spatial positioning 2004. Audio-specific neural upsampler 1730 processes each channel individually with shared network parameters while preserving channel-specific characteristics, using a modified version of the N-channel architecture described in FIGS. 11A and 11B that maintains the unique identity of each audio channel 2005. Cross-channel attention mechanisms in the neural upsampler leverage correlations between channels to recover information lost during compression, allowing information present more clearly in one channel to assist in reconstructing degraded content in another channel, particularly effective for addressing spatial masking effects 2006. Time-frequency domain transformer 1740 applies coordinated processing across channels to maintain phase coherence and spatial imaging, ensuring that the phase relationships between channels are preserved or enhanced to maintain accurate spatial positioning of sound sources within the auditory field 2007. Perceptual quality assessor 1720 evaluates both individual channel quality and inter-channel relationships using stereo or multi-channel audio quality metrics such as PEA Q (Perceptual Evaluation of Audio Quality) for stereo signals or specialized measures of spatial accuracy and envelopment for surround sound formats 2008. The enhanced multi-channel audio is reconstructed with preserved spatial characteristics, including stereo image width, depth perception, and directional cues, resulting in an immersive listening experience that maintains or enhances the spatial intentions of the original recording despite the compression-decompression process 2009.

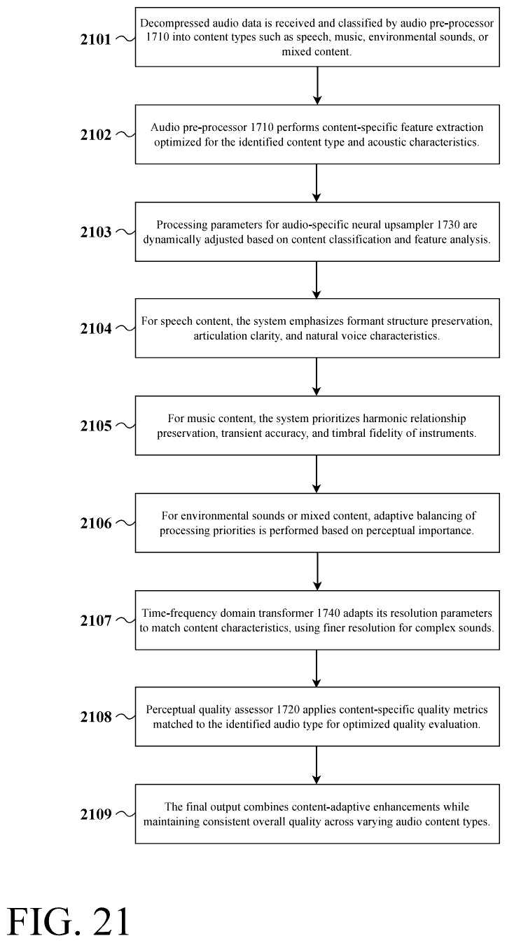

FIG. 21 is a method diagram illustrating the adaptive processing method based on audio content for audio upsampler system 1700, in an embodiment. Decompressed audio data is received and classified by audio pre-processor 1710 into content types such as speech, music, environmental sounds, or mixed content, using spectral pattern recognition, rhythmic analysis, and statistical models trained to distinguish between different audio categories 2101. Audio pre-processor 1710 performs content-specific feature extraction optimized for the identified content type and acoustic characteristics, applying specialized analysis techniques such as formant tracking for speech, harmonic structure analysis for music, or transient detection for environmental sounds 2102. Processing parameters for audio-specific neural upsampler 1730 are dynamically adjusted based on content classification and feature analysis, including modification of attention weights, filter responses, and processing depth to allocate computational resources toward the most perceptually relevant aspects of the current audio content 2103. For speech content, the system emphasizes formant structure preservation, articulation clarity, and natural voice characteristics, employing specialized processing paths that focus on maintaining intelligibility, speaker identity, and prosodic features such as intonation and rhythm 2104. For music content, the system prioritizes harmonic relationship preservation, transient accuracy, and timbral fidelity of instruments, using processing techniques that maintain the pitch relationships, attack characteristics, and spectral envelopes that define musical quality 2105. For environmental sounds or mixed content, adaptive balancing of processing priorities is performed based on perceptual importance, with the system dynamically adjusting its enhancement strategies to focus on foreground elements while maintaining realistic ambient characteristics and spatial relationships 2106. Time-frequency domain transformer 1740 adapts its resolution parameters to match content characteristics, using finer resolution for complex sounds with rapidly changing spectral content and broader analysis windows for more stationary signals, optimizing the time-frequency tradeoff based on content needs 2107. Perceptual quality assessor 1720 applies content-specific quality metrics matched to the identified audio type for optimized quality evaluation, such as speech intelligibility measures for conversational content, harmonic-to-noise ratio for music, or clarity and definition metrics for environmental sounds 2108. The final output combines content-adaptive enhancements while maintaining consistent overall quality across varying audio content types, delivering optimized reconstruction that emphasizes the perceptually important characteristics specific to each type of audio signal while preserving natural transitions between different content within the same audio stream 2109.

In a non-limiting use case example of audio upsampler system 1700, a telecommunications company deploys the system to enhance the quality of voice calls that have undergone significant compression for transmission over bandwidth-limited networks. The company collects a dataset comprising thousands of hours of high-quality speech recordings from diverse speakers across multiple languages. These recordings include various speaking styles, accents, and acoustic environments to ensure the trained system performs well across different conversational scenarios.

The company first processes this dataset by applying standard telecommunications codecs such as Adaptive Multi-Rate (AMR) at low bitrates (4.75-7.4 kbps) and Enhanced Voice Services (EVS) codecs to the high-quality recordings, creating paired examples of original high-quality speech and the corresponding compressed-then-decompressed versions. These paired examples serve as training data for audio-specific neural upsampler 1730.

During system deployment, when a compressed call audio stream at 4.75 kbps is received, decoder 120 first performs standard decompression using the appropriate codec. The resulting audio, while intelligible, exhibits characteristic compression artifacts including muffled consonants, decreased high-frequency content, and quantization noise that degrades the natural sound of voices.

This decompressed audio passes to audio pre-processor 1710, which analyzes the signal in both time and frequency domains. The speech activity detector identifies which portions contain active speech versus background noise or silence, allowing for specialized processing of speech segments. The spectral analyzer identifies regions where compression has most severely affected the signal, particularly in fricative consonants (like ‘s’ and ‘f’ sounds) which contain important high-frequency information often lost during compression.

The processed signal then flows to audio-specific neural upsampler 1730, which applies its specialized convolutional layers to extract temporal patterns from the speech. The recurrent network components model the sequential nature of speech, helping to reconstruct natural transitions between phonemes. The attention mechanisms focus particularly on restoring the spectral characteristics of consonants and maintaining the natural formant structure of vowels, leveraging the learning from thousands of examples of how these speech elements are typically degraded by the specific compression algorithm used.

The signal then passes through time-frequency domain transformer 1740, which performs short-time Fourier transforms to provide detailed spectral representation and applies Mel-scale frequency processing to weight the reconstruction according to human perceptual sensitivity. It reconstructs phase information that was discarded during compression, significantly improving the natural sound of voices and reducing the “robotic” quality often associated with heavily compressed speech.

Perceptual quality assessor 1720 then evaluates the reconstructed signal using speech-specific metrics, ensuring that the enhancement process maintains speech intelligibility while reducing compression artifacts. It applies psychoacoustic models that focus on preserving the formant structure critical for vowel sounds and the transient characteristics important for consonant clarity.

The result is a substantially enhanced call quality that approaches the clarity and naturalness of much higher bitrate transmissions. In blind tests conducted by the telecommunications company, listeners rated calls processed through audio upsampler system 1700 as equivalent to calls transmitted at 3-4 times higher bitrates. Objective measurements showed significant improvements in PESQ scores, rising from 3.2 for standard decompression to 4.1 after enhancement (on a 1-5 scale), approaching the quality of uncompressed speech which typically scores 4.5.

This enhancement allows the telecommunications company to maintain high perceived call quality while using lower bitrates, effectively increasing network capacity without requiring infrastructure upgrades. The system processes audio in near real-time with a latency of under 100 ms, making it suitable for live conversation. Furthermore, the system demonstrates robust performance across different languages, accents, and acoustic environments, successfully generalizing from its training data to handle the diverse real-world conditions encountered in global telecommunications networks.

One skilled in the art would recognize that audio upsampler system 1700 may be applicable to numerous use cases beyond those specifically described herein, and that the examples provided are non-limiting and illustrative only. The system may be deployed in various domains including but not limited to telecommunications, streaming media services, archival audio restoration, podcast production, voice assistant systems, hearing aid technology, forensic audio enhancement, gaming audio processing, and video conferencing applications. The specific implementation details, network architectures, and processing parameters may be modified according to the particular requirements of each application domain while remaining within the scope of the disclosed invention. Furthermore, while certain embodiments describe the system's application to speech signals, the techniques disclosed herein may be equally applicable to other audio types including music, environmental sounds, and mixed content, with appropriate adaptations to the preprocessing, neural network architecture, and quality assessment components. The system may be implemented on various computing platforms ranging from cloud-based infrastructures to embedded systems, depending on computational requirements and deployment constraints. Different embodiments may emphasize various aspects of audio quality improvement depending on the use case, such as intelligibility enhancement for assistive listening or aesthetic quality improvement for media production.

### Exemplary Computing Environment

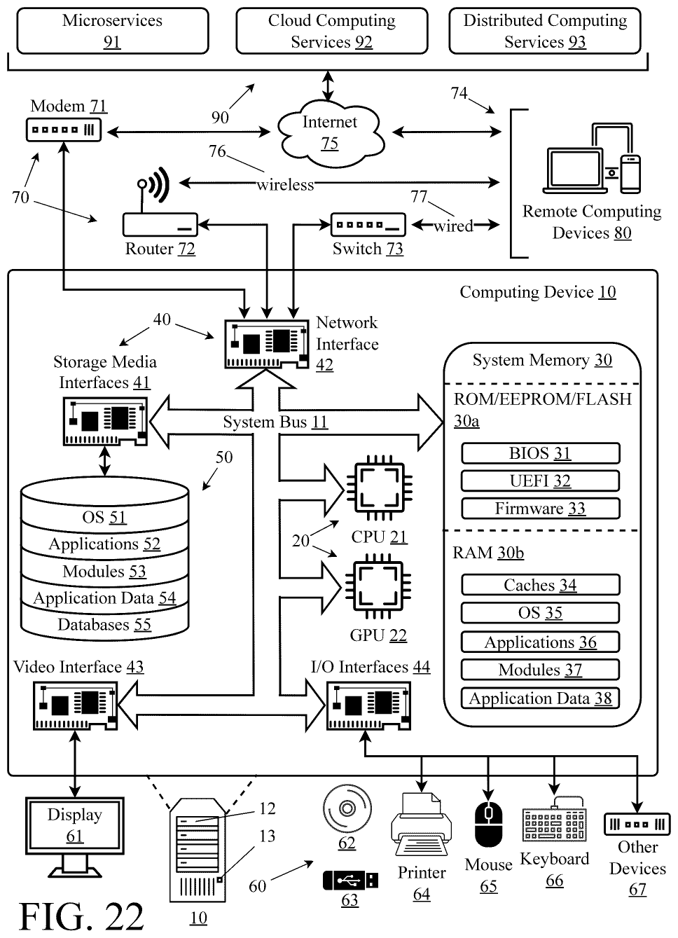

FIG. 22 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between, those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed, or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPU s) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
receive a compressed bit stream, the compressed bit stream comprising two or more substantially correlated audio channels, wherein the substantially correlated audio channels were previously compressed using lossy compression;
decompress the compressed bit stream into a decompressed bit stream;
process the decompressed bit stream with an audio pre-processor to extract spectral information, detect speech activity, segment the audio, and normalize input levels;
use the processed decompressed bit stream as input into a trained deep learning algorithm to recover information lost during the previous lossy compression of the two or more audio channels;
apply a time-frequency domain transformer to the output of the trained deep learning algorithm to enhance audio fidelity through short-time Fourier transforms and Mel-scale frequency processing; and
evaluate the transformed output using a perceptual quality assessor employing psychoacoustic models;
wherein the trained deep learning algorithm comprises a multi-channel transformer using channel-wise attention and transformer self-attention, and is trained using correlated datasets that have undergone lossy compression and subsequent decompression.

2. The computer system of claim 1, wherein the trained deep learning algorithm is a neural network that can recover signals from a compressed bitstream.

3. The computer system of claim 1, wherein the audio pre-processor comprises at least one of: a spectral analyzer for frequency domain representation, a speech activity detector for selective processing, an audio segmenter for variable-length inputs, and a normalizer for consistent input levels.

4. The computer system of claim 1, wherein the perceptual quality assessor implements at least one of: a psychoacoustic model that weights reconstruction based on human hearing, a Perceptual Evaluation of Speech Quality (PESQ) integrator, formant preservation metrics for speech clarity, and temporal structure preservation.

5. The computer system of claim 1, wherein the trained deep learning algorithm comprises at least one of: specialized convolutional layers for temporal patterns in audio data, recurrent layers for sequence modeling of audio data, and attention mechanisms optimized for phonetic structures.

6. The computer system of claim 1, wherein the time-frequency domain transformer comprises at least one of: a short-time Fourier transform integrator, a Mel-scale frequency processor, a phase reconstruction component, and a spectrogram-based attention mechanism.

7. A method for upsampling of decompressed data after lossy compression, comprising:
receiving a compressed bit stream, the compressed bit stream comprising two or more substantially correlated audio channels, wherein the substantially correlated audio channels were previously compressed using lossy compression;
decompressing the compressed bit stream into a decompressed bit stream;
processing the decompressed bit stream with an audio pre-processor to extract spectral information, detect speech activity, segment the audio, and normalize input levels;
using the processed decompressed bit stream as input into a trained deep learning algorithm to recover information lost during the previous lossy compression of the two or more audio channels;
applying a time-frequency domain transformer to the output of the trained deep learning algorithm to enhance audio fidelity through short-time Fourier transforms and Mel-scale frequency processing; and
evaluating the transformed output using a perceptual quality assessor employing psychoacoustic models;
wherein the trained deep learning algorithm comprises a multi-channel transformer using channel-wise attention and transformer self-attention, and is trained using correlated datasets that have undergone lossy compression and subsequent decompression.

8. The method of claim 7, wherein the trained deep learning algorithm is a neural network that can recover signals from a compressed bitstream.

9. The method of claim 7, wherein the audio pre-processor comprises at least one of: a spectral analyzer for frequency domain representation, a speech activity detector for selective processing, an audio segmenter for variable-length inputs, and a normalizer for consistent input levels.

10. The method of claim 7, wherein the perceptual quality assessor implements at least one of: a psychoacoustic model that weights reconstruction based on human hearing, a Perceptual Evaluation of Speech Quality (PESQ) integrator, formant preservation metrics for speech clarity, and temporal structure preservation.

11. The method of claim 7, wherein the trained deep learning algorithm comprises at least one of: specialized convolutional layers for temporal patterns in audio data, recurrent layers for sequence modeling of audio data, and attention mechanisms optimized for phonetic structures.

12. The method of claim 7, wherein the time-frequency domain transformer comprises at least one of: a short-time Fourier transform integrator, a Mel-scale frequency processor, a phase reconstruction component, and a spectrogram-based attention mechanism.
